(19) United States
(12) Patent Application Publication
(10) Pub. No.: US 2024/0394414 A1
(43) Pub. Date: Nov. 28, 2024

(54) HYBRID SYSTEMS AND METHODS FOR SECURE EXECUTION OF QUANTUM AND CLASSICAL WORKFLOWS ON ADVANCED COMPUTING DEVICES

(71) Applicant: AGNOSTIQ INC., Toronto (CA)

(72) Inventors: Santosh Kumar RADHA, Chennai (IN); William Joseph CUNNINGHAM, Sebringville (CA); Nolan Amit SHAH, Houston, TX (US); Oktay GOKTAS, Oakville (CA)

(73) Assignee: AGNOSTIQ INC., Toronto, ON (CA)

(21) Appl. No.: 18/694,405

(22) PCT Filed: Oct. 7, 2022
(86) PCT No.: PCT/CA2022/051488

§ 371 Date: Mar. 21, 2024

Related U.S. Application Data
(60) Provisional application No. 63/262,220, filed on Oct. 7, 2021.

(51) Int. Cl. G06F 21/62

(52) U.S. Cl. CPC G06F 21/629

(57) ABSTRACT

Executing workflows with different computations on different types of remote computing devices is difficult and time consuming, sometimes taking days. A system of computing devices is provided to generate a workflow of computing tasks that specify different types of computing hardware resources, including quantum computing and classical computing resources, and to generate a schedule of jobs to be executed that is consistent with the workflow. The schedule of jobs is automatically executed, as computational tasks are dispatched to different computing resource providers at different times. Two or more computational tasks can be dispatched in parallel and at the same time, according to parallel tasks in the workflow.

This patent application claims priority to U.S. Provisional Patent Application No. 63/262,220 filed on Oct. 7, 2021 and titled “Hybrid Systems And Methods For Secure Execution of Quantum And Classical Workflows On Advanced Computing Devices”, the entire contents of which are herein incorporated by reference.

### TECHNICAL FIELD

The following generally relates to hybrid systems and methods for secure execution of quantum and classical workflow computations on advanced computing devices.

### DESCRIPTION OF THE RELATED ART

Quantum computers use quantum mechanics, for example, superposition and entanglement, to perform computations. Quantum computations are not limited to two states (e.g., binary states). More particularly, quantum computers use quantum bits, also called qubits, which can exist in superposition. Qubits can also exhibit quantum entanglement. Quantum computers are used to make various computations, including in the fields of simulation, search, cryptography, linear equations, optimizations, and machine learning.

Quantum computers are realized by natural quantum systems such as natural atoms, ions or molecules, or artificially engineered materials such as superconducting circuits, quantum dots, and photonic materials that can exhibit quantum phenomena. Quantum computers are implemented in different hardware designs, including, but not limited to: gate-based quantum computing devices, measurement-based quantum computing devices, and quantum annealers. Quantum computers take in a quantum task as the input and return a bit string as the output. An example of a quantum task is in the form of a matrix, which is used for quantum annealers. Another example of a quantum task is in the form of a quantum circuit to be executed, which is used for gate-based quantum devices. A quantum circuit, for example, includes a set of one qubit or multiple qubit operations. Other types and forms of quantum tasks can be inputted into a quantum computer.

Quantum computers and non-quantum computers (also called classical computers) interact to execute computations. By way of background, classical computers refer to devices that execute binary computing, in which information is stored in bits that are represented logically by either a 0 or 1. In some instances, quantum computers operate within a fully closed data environment. In other instances, quantum computers are made accessible to third parties via non-quantum computers, which allows for more parties to make use of quantum computing capabilities that are owned or operated by other parties.

When a party wishes to execute complex computations, which sometimes include extreme amounts of data, the party uses external computation resources. For example, a party does not own a quantum computer, but will access a third-party's quantum computer through a plugin or application programming interface (API). In another example, a party will use a cloud computing service, such as cluster computing capabilities offered by the company Amazon under the trademark Amazon Web Services (AWS), or cluster computing capabilities offered by the company Microsoft under the trademark Azure. Computations using these third-party computing resources can be submitted to a third-party's queue, and the third party will execute these computations using their computing sources. These computations can take minutes, hours, or even days to finish processing.

It is herein recognized that it is desirable to control the computations executed by quantum computing hardware and classical computing hardware (e.g., non-quantum computers) in a secure manner.

U.S. Patent Application Publication to 2021/0034443 to Lowin et al. (hereinafter the '443 application) describes automating the execution of workflows at certain times, such as at a certain time, a time interval, or at a future day of the week. The '443 application also describes “hybrid” execution model and an on-premise models. In the '443 application, managed models refer to storage and execution of all code on the infrastructure owned and/or operated by the service or software provider, whereas on-premise models refer to packaging and software for deployment and execution on the end-user's infrastructure. The '443 application also describes a workflow administrator that uses metadata of a workflow (e.g., including name of one or more tasks comprising a given workflow, dependencies between various tasks, such as temporal dependencies and data dependencies, etc.) to orchestrate a workflow and initiate remote execution of the workflow. In particular, in the on-premise model, the '443 application describes the workflow administrator, a workflow registry, and a workflow engine residing on an end-users local infrastructure. It is herein recognized that this on-premise model is a closed environment.

In the alternative implementation of a system for hybrid deployment, the '443 application describes cloud infrastructure receiving requests from customer infrastructure as metadata via its API. Furthermore, the '443 application describes the cloud infrastructure of its hybrid deployment to include scheduler and metadata store, in which workflows are registered, the state of workflow is tracked by the scheduler, and state metadata is stored for reporting and analysis. The customer infrastructure periodically polls the cloud infrastructure to identify any workflows that are scheduled to run.

However, the '443 application does not account for different types of computing resources and their different attributes, and creating a schedule based on selected computing resources. A hybrid computing system, involving both quantum computing hardware and classical computing hardware, is also not addressed. Nor does the '443 application address incorporating quantum inspired computing hardware.

It is herein recognized that existing workflow execution systems do not account for selected constraints, nor do they optimize based on selected strategies. Existing workflow execution systems operate with preset parameters, instead of with the flexibility of user-selected parameters, which can lead to computations and results that are inappropriate for processing the user's algorithms.

It is also herein recognized that storage of certain types of data on external computing systems, such as cloud computing systems, pose various risks and burdens on the external computing systems, for example, security burdens and computational burdens.

It is also herein recognized that other examples of challenges posed in establishing and executing computation workflows across different computer systems include: tracking different versions of experiments; providing a data platform that shares computational experiment data; managing different user accounts across different computational clusters; checkpointing long computational simulations; compiling and incorporating code from different developers (e.g., coders); and selecting and timely activating different computational hardware resources, including classical computing hardware and non-classical computing hardware.

### BRIEF DESCRIPTION OF THE DRAWINGS

Embodiments will now be described by way of example only with reference to the appended drawings wherein:

FIG. 1A is a schematic diagram of a hybrid computing system, including non-quantum computers and quantum computers, for controlling the workflow of computations across different types of computing hardware, according to an example embodiment.

FIG. 1B is a schematic diagram of a hybrid computing system similar to FIG. 1A, but the dispatcher hardware and software are part of a user machine and a scheduler server system, according to another example embodiment.

FIG. 2A is a schematic diagram of the hybrid computing system shown in FIG. 1A, further showing additional components and software modules, according to an example embodiment.

FIG. 2B is a schematic diagram of the dispatcher server system, shown in isolation, and including a queue module, according to another example embodiment.

FIG. 3 is a schematic diagram of workflow data including task nodes and data associated with each task node, according to an example embodiment.

FIG. 4A is flow diagram of example executable instructions for generating a workflow and computing a schedule of jobs, according to an example embodiment.

FIG. 4B is flow diagram of example executable instructions for generating a workflow and computing a schedule of jobs, including using a queue to buffer and track incoming requests, according to an example embodiment.

FIG. 5 is a schematic diagram of workflow metadata extracted from the workflow data shown in FIG. 3, according to an example embodiment.

FIG. 6 is flow diagram of example executable instructions for computing a schedule of jobs, according to an example embodiment.

FIG. 7A is an example of a scheduled jobs metadata for a given task outputted by a scheduling server system, according to an example embodiment.

FIG. 7B is an example of an input provided to an executor module for a given task comprising a combination of at least the scheduled jobs metadata of the given task from FIG. 7a, execution data, and dispatcher configuration data.

FIG. 8 is flow diagram of example executable instructions for extracting metadata from classical compute tasks and quantum compute tasks, according to an example embodiment.

FIG. 9 is flow diagram of example executable instructions for obfuscating a quantum circuit of a quantum compute task, and then extracting metadata from the obfuscated quantum circuit, according to an example embodiment.

FIG. 10A is an example screenshot of a graphical user interface (GUI) that displays a listing of workflow jobs executed or to-be-executed by the workflow application.

FIG. 10B is an example screenshot of a GUI showing details of a certain workflow job, shown after a certain job in FIG. 10A is selected by a user input.

FIG. 10C is an example screenshot of a GUI showing details about a certain node, shown after the certain node in the workflow in FIG. 10B is selected by a user input.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Within this specification, different structural entities (which may variously be referred to as “nodes”, “units”, “circuits”, “systems”, “processors”, “module”, “interface”, other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform one or more tasks during operation. A structure can be said to be “configured to” perform some task even if the structure is not currently being operated. A “processor configured to generate and transmit a message via a data port” is intended to cover, for example, an integrated circuit that has circuitry that performs this function during operation, even if the integrated circuit in question is not currently being used (e.g., a power supply is not powering it). Thus, an entity described or recited “configured to” perform some task refers to something physical, such as a device, circuit, memory storing program instructions executable to implement the task, etc. This phrase is not used herein to refer to something intangible. Thus, the “configured to” construct is not used herein refer to a software entity, such as an application programming interface (API).

The term “configured to” is not intended to mean “configurable to.” An unprogrammed Field Programmable Gate Array (FPGA), for example, would not be considered to be “configured to” execute some specific operation, although it may be “configurable to” perform that specific operation and may be “configured to” execute that specific function after programming.

Reciting in the appended claims that a structure is “configured to” perform one or more tasks is intended not to be interpreted as having means-plus-function elements.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this specification, numerous specific details have been set forth. It is to be understood, however, that implementations of the disclosed technology may be practiced without these specific details. In other instances, well-known methods, structures, and techniques have not been shown in detail in order not to obscure an understanding of this description. References to “for example”, “some examples,” “other examples,” “one example,” “an example,” “various examples,” “one embodiment,” “an embodiment,” “some embodiments,” “example embodiment,” “an example aspect”, “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Quantum computing capabilities continue to improve and are becoming more accessible to different industries. For example, quantum computing architecture is structured so that a quantum computing hardware can be accessed by non-quantum computers (also called classical computers). In particular, a non-quantum computer sends a quantum task, such as, but not limited to, a quantum circuit, to a quantum computer for processing and the results from the quantum computer are returned to the non-quantum computer. In some example embodiments, there are quantum computing cloud services that are accessible via a network, such as the Internet. This allows other parties to use quantum computing resources more easily. For example, a non-quantum computer generates a quantum circuit and sends the same to a quantum computer. In turn, the quantum computer executes computations on the quantum circuit and the results are returned to the non-quantum computer. Quantum computers are also herein called quantum computing devices, quantum devices, quantum computing hardware, and the like.

Quantum workloads are unlike classical cloud workloads. There are only a small number of quantum devices in the world relative to the number of computers available. The scarcity of these devices means that users may need to wait for device access. It is also herein recognized that other types of quantum inspired devices, such as digital annealers and simulated bifurcation machines, could also be selected for cloud workloads. Classical cloud workloads do not have a scarcity problem but there are many types of cloud resources including tensor cores (also called tensor processing units (TPUs)), graphic processing units (GPUs), memory-optimized cloud servers, central processing units (CPUs) that might need to be selected for a particular workload.

In an example embodiment, a scheduling and workflow executing computing system is provided which handles computing resource scarcity and selection with its internal scheduler. It abstracts away the need to know about underlying hardware types and available computing clusters by providing a user interface that receives user specified “constraints” on the type/amount of compute, the urgency, the cost, or other factors. The scheduler in the system uses those constraints to pick a quantum compute device or a classical backend device that is most suitable.

It will be appreciated that the term “workflow” is used herein to refer to a process comprising a number of discrete computational tasks that perform function on or read data to or from, or both, end-user computing infrastructure. The tasks may be dependent on each other, following a sequence of tasks. For example, the tasks are dependent on each other from a data perspective. For example, a data output from one task is a data input for a subsequent task. In another example, the tasks are dependent on each other from a temporal perspective.

The term “job” refers to a task with an assignment to a particular computing device for processing, including sequence or timing information.

The term “hybrid computing system” herein refers to a system of computers that comprises classical computers and quantum computers.

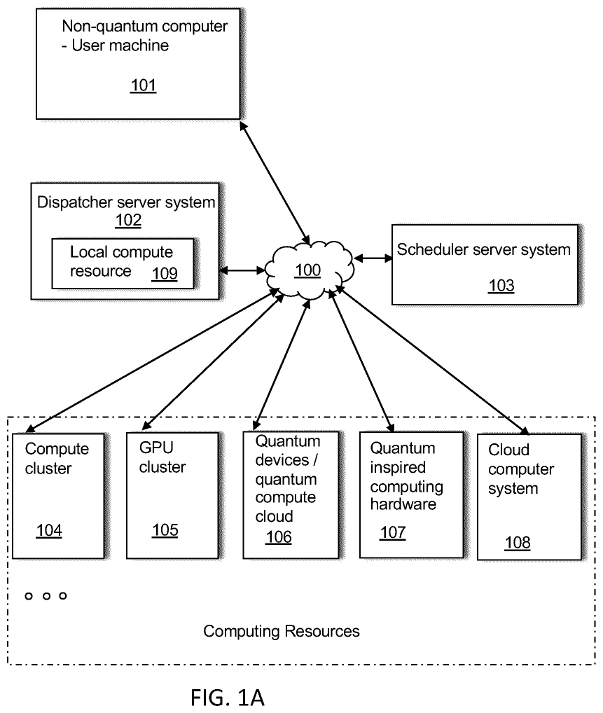

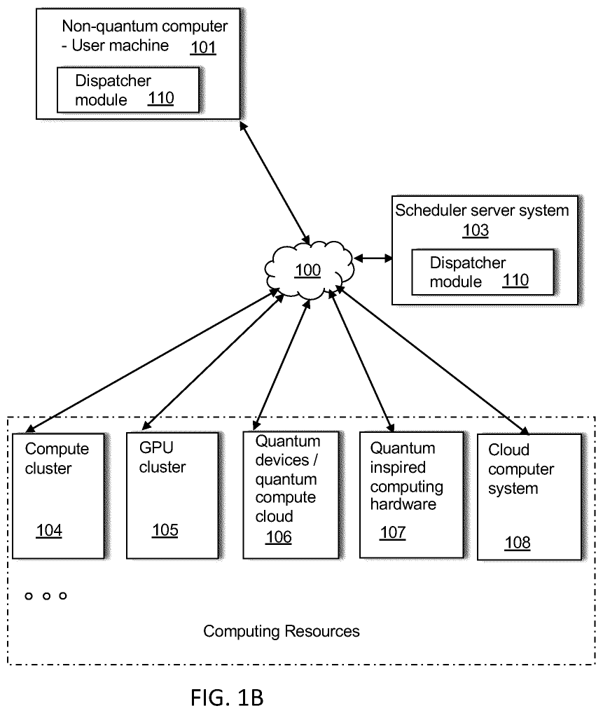

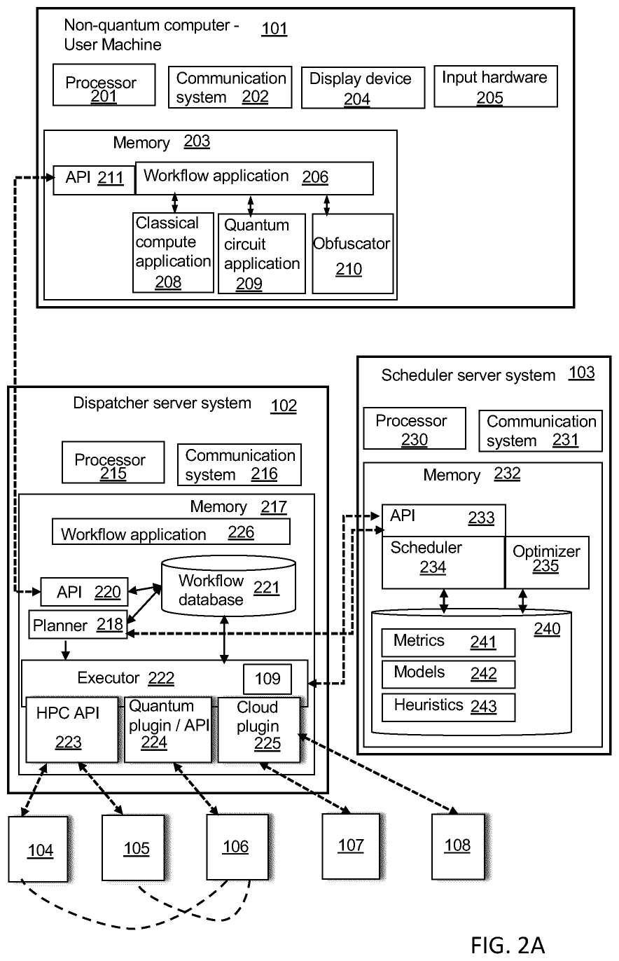

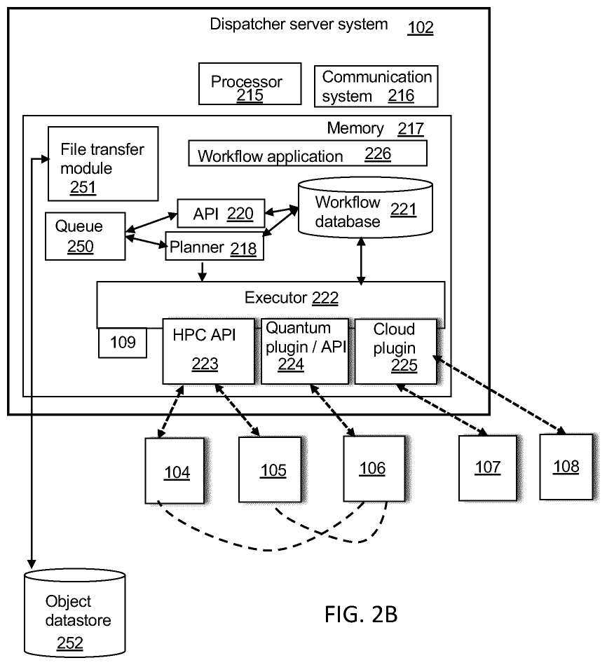

Turning to FIG. 1 and FIG. 2, an example embodiment of a computing system infrastructure is shown. In an example aspect, the system is a hybrid computing system that includes classical computers and quantum computers that interact with each over a communication network 100. For example, the communication network includes the Internet. In another example aspect, the communication network also includes a private network, such as private wired network or a private wireless network, or both. A classical computer that is a user machine 101, also called a user terminal, interacts with a dispatcher server system 102 via the network 100. Examples of user machines 101 include a laptop, a desktop computer, and a tablet computer. In another example embodiment, a user machine 101 is a cloud server accessed via a web browser or a Linux terminal, and the cloud server is used by the user to log in with credential and access a read/write file system. In a preferred embodiment, the dispatcher server system 102 can communicate with multiple user machines 101.

In an example embodiment, the one or more user machines 101 and the dispatcher server system 102 are part of the same party or organization. For example, a company owns or operates the dispatcher server system 102 and the employees of the company use their respective user machines 101 to access the dispatcher server system 102 to arrange computational workflows. In this way, a team of developers can control large workflows, including monitoring and revising an existing workflow with computations in progress.

In an alternative example embodiment, the software modules on the dispatcher server system 102 and the software modules on a user machine 101 instead reside on one computing device, with a user terminal, such as a desktop computer.

The dispatcher server system 102 is in data communication with a scheduler server system 103 over the network 100. The dispatcher server system 102 is also in data communication with one or more computing resources. Examples of computing resources include a compute cluster 104, a GPU cluster 105, a quantum computing device 106, a quantum inspired computing device 107 (e.g., a digital annealer device), a cloud computer 108 (e.g., a virtual machine). These computing resources can be third-party resources that are available as a service to be used by other parties.

In an example aspect, a compute cluster is a collection of computing servers managed by a batch queuing system, with shared low-latency storage, often with a focus on many-core or large-memory systems. A GPU compute cluster is a type of compute cluster. Other types of processing devices, including CPUs and TPUs, can be used in compute clusters. Some compute clusters are high performance clusters (HPCs). A HPC cluster includes hundreds or thousands of computer server machines that are interworked together to boost processing speed and performance. These types of computing resources can be specified by the user as an attribute associated with a given task in workflow.

Batch processing computing systems and services are used to run batch processing on classical computers, such as a computer cluster or a cloud computing system. Examples for cluster batch processing systems include Simple Linux Utility for Resource Management (SLURM or commonly Slurm), Load Sharing Facility (LSF), and Portable Batch Systems (PBS). A batch processing type or a related parameter, or both, can be specified by the user as an attribute associated with a given task in workflow.

In addition, the computing resources include low-powered classical computing machines, such as a single server or a single virtual machine, with a few processing cores. In other words, the computing resources of the classical computing type can include other types of computing hardware not necessarily being large scale computing systems.

Some examples of quantum computing devices include quantum gate-based computing devices and quantum annealer computing devices. Examples of quantum computing devices include those provided by D-Wave, IBM, IonQ, Xanadu, and Rigetti. Another example of a quantum computing device is a measurement-based quantum computing device, and an example of which is provided by the PsiQuantum. The type of quantum computing device, which may include the provider, can be specified by the user as an attribute associated with a given task in a workflow.

Other types of computing resources can be specified for a given task in a workflow, including but not limited to quantum-inspired devices. For example, a digital annealer device includes a digital annealer unit (DAU), which is a custom CMOS chip with an architecture designed to address large-scale optimization problems more efficiently. The DAU is inspired by quantum mechanics, but unlike quantum computers, does not require specific hardware that hosts quantum phenomena like superposition and entanglement, and therefore does not need extreme environments like cryogenic temperatures.

It will be appreciated that even within a computing cluster 104, there are different service providers and different types of hardware. Similarly, within the grouping of quantum devices 106, there are many different types of quantum computing devices. The scheduler server system 103 executes processes to determine the specific computing resource that satisfies the constraints and optimizes strategies selected by the user.

In another example embodiment, one or more of these computing resources can be owned by the same company or party that operates the dispatcher server system 102. In another example embodiment, local compute resources 109 (e.g., virtual machines, processor(s), or GPUs, or combinations thereof) that reside on the dispatcher server system 102 can be locally used to execute a workflow. For example, a combination of cloud computing (e.g., one or more of the compute resources 104, 105, 106, 107 and 108) can be used in combination with the local compute resource 109 to executed a workflow.

In another example embodiment, different companies or organizations have their own dispatcher server system 102 and one or more user machines 101. Multiple dispatcher server systems 102 operated by different companies can interact with the scheduler server system 103. For example, the scheduler server system executes scheduling operations to allocate computing resources for a workflow to different companies or customers. The scheduler server system 103 receives workflows from one or more dispatcher server systems 102 and creates a job schedule data for each workflow. The job schedule data is returned to the respective one or more dispatcher server systems and is used by the respective one or more dispatcher server systems to control the appropriate the computing resource 104, 105, 106, 107, 108.

In an example operation of controlling a workflow, a user interacts through a user interface at their user machine 101 to build a workflow. The workflow is sent to the dispatcher server system 102 for validation. The dispatcher server system 102 then sends metadata of the workflow to the scheduler server system 103. Metadata of the workflow refers to data about the description and context of the workflow, but excludes the actual workflow data (e.g., including executable instructions, code, and data arguments). It will be appreciated that an argument is a value passed into a function. For example, if a function is X+Y, then the arguments are the values passed into the variables X and Y. The scheduler server system 103 uses the metadata of the workflow to generate a schedule of jobs. The schedule of jobs includes metadata that identifies the specific computing resource to be used for each task. The scheduled jobs metadata is sent or returned to the dispatcher server system 102. The scheduled jobs metadata, like the workflow metadata, also excludes the actual workflow data (e.g., including executable instructions, code, and data arguments).

In an example aspect, the scheduled jobs metadata does not include timing information for the tasks. In another example aspect, the scheduled jobs metadata does not include the order or sequence of the tasks. The dispatcher server system 102 stores the sequence of the tasks and the dispatcher server system 102 executes the tasks according to this sequence. In other words, the scheduling process herein refers to allocating tasks to the external computing resources.

The dispatcher server system 102 then uses the scheduled jobs metadata to execute the workflow. In particular, the dispatcher server transmits executable instructions or code, and any related data, to a specified computing resource.

For example, the dispatcher server system 102 transmits a first set of code and data to a specific computing cluster 104, and the computing cluster returns a first set of data results. The dispatcher server system then transmits a second set of code and the first set of data results, which is the input data to the second set of code, to a specific GPU cluster 105. The GPU cluster returns a second set of data results to the dispatcher server system. The dispatcher server system then transmits the second set of data results and a quantum circuit (e.g., a third set of code) to a specific quantum device 106, which returns quantum circuit results. The dispatcher server system then transmits the quantum circuit results and a fourth set of code to another specific computing cluster 104 to post-process the results. While the dispatcher server system executes the jobs in coordination with the computing resources, the scheduler server system creates the arrangement and the specification of the computing resources.

A server system can include one or more server machines in communication with each other. For example, the dispatcher server system and the scheduler server system each include one or more server machines.

In an alternative example embodiment shown in FIG. 1B, the hardware and software for executing the dispatcher do not reside on a separate dispatcher server system. Instead, a dispatcher module (which has access to the hardware and software) resides on the user machine 101 and on the scheduler server system 103. In other words, the dispatcher runs locally on the user machine 101 and the scheduler server system 103.

As shown in more detail in FIG. 2A, the user machine 101 includes a processor system 201, a communication system 202, a work system 203, a display device 204, and input hardware 205. Examples of input hardware include a keyboard, a trackpad, and a mouse. The memory 203 stores thereon data and applications, including a workflow application 206. In an example aspect, data, such as a user client library associated with a workflow application, stores metadata about a workflow in the memory, and not necessarily in a database. In an example embodiment, a classical compute application 208, a quantum circuit application 209, and an obfuscator application 210 are also stored in the memory 203. The classical compute application 206, for example, is a software developer tool for writing code. The quantum circuit application 209, for example, is a software tool for building quantum circuits. The obfuscator application 210, for example, is a software application that obfuscates a quantum circuit and decodes results from an obfuscated quantum circuit. An application programming interface (API) 211 facilitates communication between the workflow application 206 on the user machine 101 and software modules on the dispatcher server system 102.

In an alternative example embodiment, the workflow application 206, the classical compute application 208, the quantum circuit application 209, and the obfuscator application 210 reside on, and are executed by, the dispatcher server system 102, and are accessible to the user machine 101 via a dedicated interface application or a web browser application on the user machine 101.

The dispatcher server system 102 includes a processor system 215, a communication system 216, and a memory system 217. Software and data are stored in the memory 217, including an API 220 that facilitates communication with workflow applications operating on one or more user machines 101. The software modules on the dispatcher server system 102 also include a planner module 218 and an executor module 222. These modules interact with a workflow database 221.

The workflow database 221 stores workflow data, job data, and status data. It also includes current status data of completed workflow processes, which can be used to retry a computation of a given task, pause a computation of a given task, or resume a computation of a given task, or a combination thereof.

The planner module 218 obtains a workflow with the metadata of the workflow, obtains a schedule from the scheduling server system, and then submits the scheduled workflow to the executor. module. The planner module may also obtain or generate additional metadata, e.g., related to classical HPC backends, which is sent to the scheduler server system in conjunction with the user-provided metadata.

The executor module 222 includes different plugins that invoke or trigger backends or APIs, such as a compute server, a high-performance computing cluster, a cloud batch computing service, or a quantum computing API, or a combination thereof. Plugins can run jobs on backends or services or clusters, or a combination thereof, that use APIs or a secure socket shell (SSH) or any other applicable communication mechanism. In this way, the executor module 222 communicates with different types of computing resources or different computing resource service providers, or both. For example, the executor module includes a plugin for invoking a HPC API 223, which can communicate with a compute cluster 104 and a GPU cluster 105. The executor module also includes a quantum plugin 224 to communicate with quantum devices or quantum cloud computers 106. The executor module also includes a cloud plugin 225 to communicate with batch processing computer systems.

In an example embodiment, different computing resources directly communicate data with each other to execute a task or a series of tasks. In other words, data does not need to be exchanged with one of the APIs 223, 224, 225 in order for one computing resource to communicate with another computing resource. For example, the compute cluster 104 and the quantum devices or quantum compute cloud 106 exchange data directly with each other. In another example, the GPU cluster 105 and the quantum devices or quantum compute cloud 106 directly exchange data with each other. In an example aspect, the dispatcher server system 102, via the one or more APIs, transmits security authorization to the different computing resources (e.g., 104, 105, 106, etc.) to enable these different computing resources to establish a secure communication channel directly amongst each other, through which data is exchanged.

In another example embodiment, a local compute resource 109 on the dispatcher server system, which is a classical compute resource, is activated by the executor module 222.

In an example aspect, the executor module 222 also includes an interoperability plugin for software that facilitates interoperability with different quantum frameworks and devices, an example of which is available under the trade name PennyLane. In particular, a software framework is provided for differentiable quantum computing, and a corresponding interoperability plugin allows quantum computations to interact with other quantum frameworks and devices. In an example aspect, the interoperability plugin obfuscates the underlying quantum hardware's mechanisms. The scheduler server system 103, with some high-level input from the user, determines on which specific hardware a quantum circuit should be run on.

In another example aspect, classical computing APIs and plugins store credentials and manage communication with the classical computing resources (e.g., GPUs, TPUs, processing clusters, virtual machines in cloud computing systems, etc.). For example, a classical compute batch computing resource, available under the trade name Amazon Web Services (AWS), requires AWS credentials, queue ID, compute environment specs, etc. In another example, a containerized computing API or plugin, which is available under the trade name Kubernetes, requires credentials, cluster path, presence of GPU, etc.

The scheduler server system 103 include a processor system 230, a communication system 231, and a memory system 232. The memory stores thereon software and data, include an API 233, a scheduler module 234, and an optimizer module 235. The scheduler module obtains metadata of a workflow to generate a schedule of jobs. The optimizer module uses one or more user-selected or user-defined strategies to optimize the schedule of jobs.

A database 240 on the scheduler server system stores thereon metrics data 241, models 242, and heuristics 243. Examples of metrics data includes cost per task, cost per hour, and the number of tasks in a queue. Examples of heuristics data includes estimated or predicted metrics when observed or measured data is not available. Heuristics data also includes qualitative data, such as, for example, a quality rating of a computed solution. Heuristics data is also helpful because metrics data provided by different computing resource providers is inconsistent, and the heuristics data can be used to supplement these inconsistencies. Models refer to scheduling models, which include computational conditions and framework for determining how to schedule a job. Examples include meeting constraints and using mathematical models to optimize certain metrics or heuristics values. In an example aspect, metrics and heuristics are inputs to one or more of the models.

In a more detailed example embodiment, a user (also called a developer or a coder) uses a classical computing application 208 or a quantum circuit application 209, or both, via their user machine 101, to develop or write executable instructions (e.g., code, or quantum tasks, or quantum circuits, or a combination thereof). Aspects of the code or the quantum circuits, or both, are inputted into the workflow application 206. Using a typographical user interface or a graphical user interface in the workflow application 206, a workflow project is created according to the user's selections. This data of workflow project (also herein called workflow data) is stored locally on user machine in the database 207.

The data of the workflow project is transmitted from the user machine 101 to the dispatcher server system 102 via the APIs. In an example aspect, the workflow created by the user is preferably validated by the validator module 219. If the validation is successful, the validated workflow is processed by the planner module 218. It will be appreciated that copies of the workflow, and other related data (e.g., validation results, invalidation errors, version IDs, status updates, etc.) are stored on the workflow database 221. The planner module 218 extracts metadata from the workflow, also herein called “workflow metadata”, and sends the extracted workflow metadata to the scheduler server system 103 via APIs. In an example aspect, the workflow metadata is in the form of a JavaScript Object Notation (JSON) file. In another example aspect, the workflow metadata is in the form of a text file. Other data formats can be used to store and transmit the workflow metadata.

The scheduler server system 103 uses the workflow metadata to generate a schedule of jobs. In an example aspect, the optimizer module 235 uses the workflow metadata, including one or more strategies selected by the user, to generate an optimized schedule. For example, the schedule of jobs is optimized for the shortest time, or for the lowest cost, or for the highest reliability. The scheduler server system then returns metadata about the scheduled jobs, also herein called “jobs metadata” or “scheduled jobs metadata”, to the planner module 218. In an example aspect, the scheduled jobs metadata is in the form of a JSON file. In another example aspect, the scheduled jobs metadata of the workflow is in the form of a text file. Other data formats can be used to store and transmit the metadata.

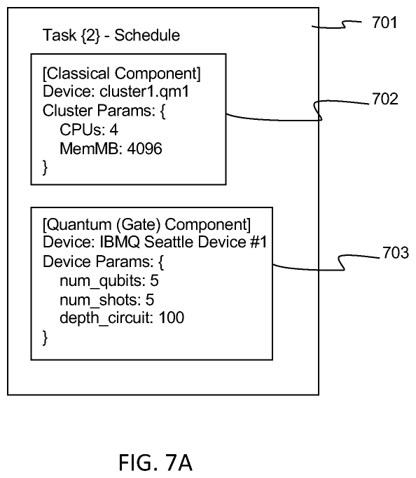

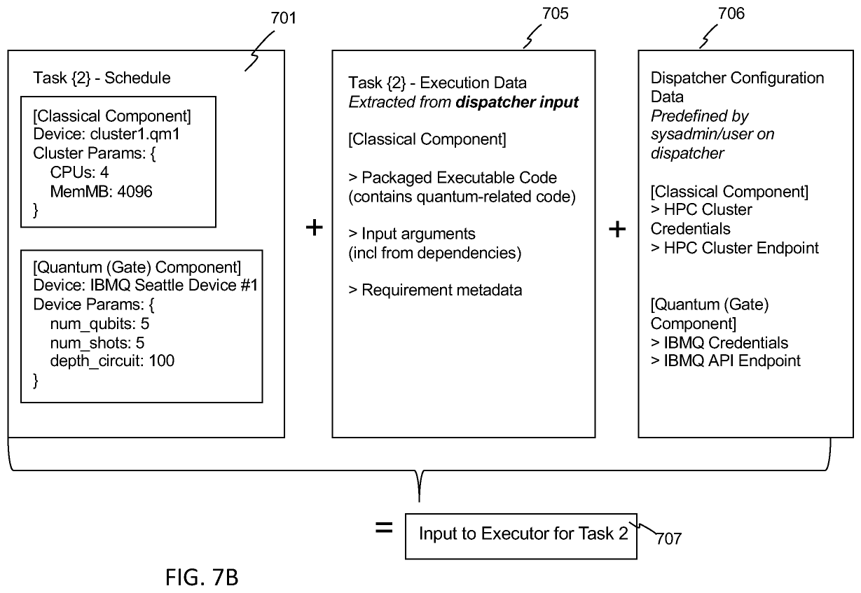

The planner module integrates the workflow data and the scheduled jobs metadata to generate an executable-ready workflow. The executable-ready workflow includes workflow data and a schedule that defines specific computing resources to be used. An example of executable-ready workflow data for a given task is shown and described below in relation to FIG. 7B.

The executable-ready workflow data for a given task includes, for example, a specified computing resource, parameters (also herein called backend parameters) associated with using the specified computing resource, executable instructions or code, input data, function arguments, access credentials to use the specified computing resource. This executable-ready workflow data is executed by the executor module 222, which transmits at least the backend parameters, executable instructions or code, and input data, of the given task in the workflow to the specified computing resource, as specified in the scheduled jobs metadata of the given task. This is repeated by the executor module 222 for each task in sequence according to the workflow.

Turning to FIG. 2B, another example embodiment of a dispatcher server system 102 is provided, which further includes a queue module 250. The queue module 250 acts a data buffer to receive incoming requests and tracks the progress or execution of the requests. For example, the dispatcher server system receives tens or hundreds of incoming requests for workflows, or changes to workflows, originating from one or multiple user machines 101. These incoming requests are stored on the queue module 250, and the requests remain in the queue module 250 until they are processed by dispatcher server system 102. For example, a request is received by the API 220, and the request is added as an entry into the queue module 250. The request is also entered into the workflow database 221. The workflow application 226 creates a workflow plan with the planner 218, which addresses the request stored in the queue module 250. After, the dispatcher server system 102 deletes the request from the queue module 250. It will be appreciated that the queue module is a way to throttle or control the processing of the requests that are being received by the dispatcher server system 102.

In another example aspect, a file transfer module 251 is included on the dispatcher server system 102. The file transfer module 251 communicates with an object datastore 252, and the object datastore 252 can be stored locally on the dispatcher server 102 or remotely on another server. Input data for tasks, for example, amongst other types of data objects are stored on the object datastore 252. The file transfer system 251 includes a mapping between data objects stored on the object datastore 252 and data references used by the workflow database 221. In other words, the workflow database 221 includes data references (which can be in the form of data links), and these data references are sent to the file transfer module 221. In return, the file transfer module 251 retrieves the data object from the object datastore 252 that corresponds to the data reference. In an example embodiment, the object datastore 252 is stored in a separate server from the dispatcher server system 102, so that if a failure occurs on the dispatcher server system 102, the data objects in the object datastore 252 remain safe.

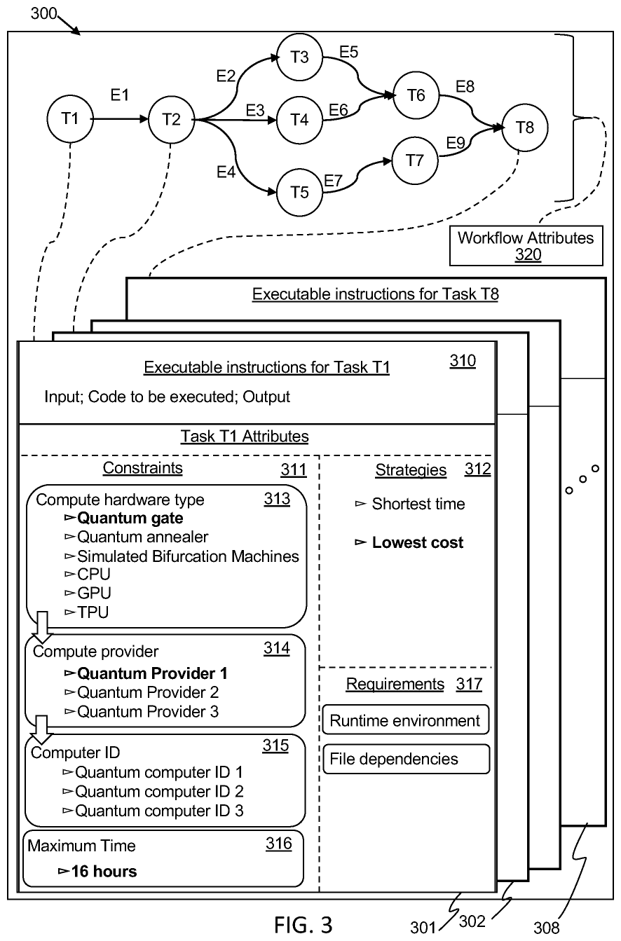

Turning to FIG. 3, an example embodiment of a workflow project 300 is shown as a sequence of tasks T1, T2, T3, T4, T5, T6, T7, and T8. The tasks are connected to each other via edges to form a workflow, also herein called a lattice. Each task includes executable instructions and task attributes. The tasks can be relationally organized with each other using a directed graph, where each task is a node or vertex in the graph. The tasks are also herein referred to as a task node. The edges between the tasks define the relationship between the tasks. For example, the output data of a preceding task forms part of, or all of, the input data of a subsequent task. The edge E1 defines the relationship between the task T1 and T2, and can specify that the output of T1 becomes an input of T2. Similarly, the edge E2 defines the relationship between T2 and T3; the edge E3 defines the relationship between T2 and T4; the edge E4 defines the relationship between T2 and T5; and, so forth for edges E5, E6, E7, E8, and E9. In the example shown, the sequence of tasks is clear from the directed graph 300. The directed graph also shows that the tasks T3, T4, and T5 can be executed in parallel to each other. In other words, they can be executed at the same time using different computing resources to reduce the time to complete processing the entire workflow.

In an example aspect, the data 301 is associated task T1; the data 302 is associated with the task T2; and so forth including that the data 308 is associated with the task T8. In other words, each task is associated with data.

Each task will have associated with it metadata comprising the task attributes and the relational data defined by the edges between tasks. The metadata of each of the tasks together form part of the workflow metadata.

In an example aspect of the data 301, it includes executable instructions 310 for the task T1. The executable instructions include, for example, input definitions, code to be executed, and output definitions. The data 301 also includes attributes, such as constraints 311 and strategies 312. The constraints define parameters that are required to be met when executing this task, or in other words, when executing the executable instructions 310. Constraints are conditions that are required to be satisfied, or are conditions that are given high priority to be satisfied when the scheduler server system creates a schedule for a workflow. The strategies define parameters or goals that are desirable to be satisfied as much as possible, but are not required to be satisfied when the scheduler server system creates the schedule for a workflow. In an example aspect, the strategies establish a range of conditions and are used to optimize certain values (e.g., time, reliability, cost, geography, etc.).

The constraints are selectable or definable by the user. In another example aspect, the strategies are selectable or definable by the user.

In an example embodiment, the visualization of the workflow 300 in the form of a directed graph and the data 301, 302, 308 visualized as a panel in association with each task node T1, T2, . . . , T8 are elements of an example graphical user interface (GUI). In an example aspect, the elements of the GUI shown in FIG. 3 are interactive and can be selected using a pointer. A user can view, insert, modify, select, or remove constraints and strategies, or a combination thereof. A user can also use the GUI to view, insert, modify, select, or remove executable instructions associated with each task or task node. In another example embodiment, the user interface is typographical, or text based, such as in the form of code. It will be appreciated that different visualization and user interface configurations can be used to form a workflow of tasks, and to facilitate a user's definition of the task (e.g., executable instructions, such as code), and to facilitate a user's selection or specification of constraints and strategies.

Continuing with FIG. 3, example constraints include the computing hardware type 313, the compute provider 314, the compute provider location 315, and the maximum time 316 to complete the computation of the task T1. Other types of constraints can be used. In an example embodiment, options are shown for each constraint and the use selects one of the options. In another example embodiment, the user can insert a value or parameter associated with a constraint.

In another example aspect, constraints can be linked. In particular, selecting a specific option for one constraint automatically narrows or filters out potential options in other constraints. For example, each constraint type is a data object that is linked to other data objects belonging to other constraint types. For example, selecting a specific a computing hardware type, which is a data object under the computer hardware type, will automatically display the related options for the compute provider, which are linked data objects under the computing provider type, that can provide the selected specific computing hardware type.

The example constraints 311 in the workflow application provides options for a computing hardware type 313, including quantum gate, quantum annealer, DAU, simulated bifurcation machines (SBMs), CPU, GPU, and TPU. It will be appreciated that other currently known and future-known types of quantum computing hardware and classical computing hardware can be provided as options. Each of these options are data objects under the computing hardware type.

In the example in FIG. 3, which shows “Quantum gate” in bold font, the user has selected that a computing hardware type of quantum gates is required to be used to execute the computations of the task T1. This data object of quantum gates is linked to specific compute providers, generally shown as Quantum Provider 1, Quantum Provider 2, and Quantum Provider 3 in FIG. 3. In an example aspect, Quantum Provider 1 shows the tradename IBM Quantum for IBM's quantum device hardware, Quantum Provider 2 shows the tradename IonQ which provides and operates its own ion-trap quantum devices, and Quantum Provider 3 shows the tradename Rigetti which provides and operates its own quantum devices. These options are also data objects under the compute provider type, which are linked to the quantum gate data object. Therefore, selection of the quantum gate computing hardware type automatically shows IBMQ, IonQ, and Rigetti as options under the computing provider 314. It will be appreciated that other types of quantum computing devices and their operators or providers can be listed, including, and not limited to, ion-trap quantum devices from the company Honeywell International Inc. and quantum annealing devices from the company DWave Systems Inc.

In the example in FIG. 3, which shows “Quantum Provider 1” in bold font, the user has selected Quantum Provider 1, and this data object for compute provider is data linked to several quantum computer IDs, shown as Quantum Computer 1, Quantum Computer 2, and Quantum Computer 3. These are data objects under the computer ID type 315. In the example shown, the user has made no selection on the quantum computer ID. In other words, the specific quantum computer ID is not a constraint for the task T1. Therefore, the scheduler module 234 can select any of the quantum computer IDs as available.

In the example shown, the user has also specified that the maximum time constraint 316 to complete the computations for the task T1 be 16 hours.

The types of constraints can vary. For example, different computing hardware types have different types of related constraints, herein called sub-constraints or child constraints. Furthermore, different computing providers or operators have their own types of constraints. The types of constraints also depend on the algorithm or code being executed in a task. Examples of different constraints include accuracy, qubit count, number of CPU cores, number of GPU cores, location, error rate, cost on the future, and number of shots. A cost on the future refers to a value of a given constraint affecting a value of a future related constraint. For example, a value of a cost constraint for a given task affects the remaining available global cost constraint for assigned to the entire workflow. A number of shots refers to the number of times a quantum circuit is executed or measured. By way of background, the classical output of a quantum circuit is either a probability distribution of the resulting output values, or an average of the output values, called the expectation.

Examples of options for strategies 312 include shortest time and lowest cost. In an example aspect, the user has selected the lowest cost strategy. Therefore, the scheduler module will generate a job schedule for the task T1 that will lower the cost of the compute service.

It will be appreciated that there may be other types of constraints and strategies.

In an example aspect, as shown in FIG. 3, constraints and strategies are stored in memory and accessible to the workflow application 206 or 226, or both, and, more particularly, are stored in a relational database. For example, different types of constraints are stored in a database to show relationship between each other, including, but not limited to hierarchical relationships. For example, different constraints are stored a hierarchical data tree structure. Consider, constraints for the different hardware types (e.g., quantum gate, quantum annealer, SBM, DAU, CPU, GPU, and TPU) are each nodes in a data tree structure, and associated with the quantum gate node are the child nodes Quantum Provider 1, Quantum Provider 2, and Quantum Provider 3. Associated with the node Quantum Provider 1 is the further child node Quantum computer ID 1, Quantum computer ID 2, and Quantum computer Id 3. Similarly, the GPU node will have associated with it a separate set of constraints organized as child nodes. For example, the GPU node is associated with child nodes such as GPU Provider 1, GPU Provider 2, and GPU Provider 3; and, each GPU Provider node may have its own associated child nodes specifying the GPU computer ID.

In an example aspect, using the hierarchical relationship, when a user specifies a certain child node constraint, then the workflow application automatically applies the parent node constraints associated with the child node to the given task node. For example, if a user specifies in the workflow application that a constraint for task T1 is to use Quantum Provider 1, which is linked to the quantum gate constraint, then the workflow application subsequently and automatically applies the quantum gate constraint to the same task T1.

In another example aspect, one or more of the constraints are independent and are not data linked to other constraints. For example, the maximum time constraint is not data linked to other constraints.

In another example aspect, the attributes further include requirements 317, The requirements, for example, are static and are specified by the user. In other words, the requirement, once specified, does not change throughout the computation. An example of a requirement is a runtime environment (e.g., one or more software packages and toolkits that must be installed on the computer backend in order to process a task). Another example of a runtime environment are one or more file dependencies, which are list of input and output file names for each task.

It will be appreciated that different tasks can have different executable instructions, and different constraints and different strategies. For example, user selects the constraints for the task T2, which are different from the constraints selected in the task T1. Other types of constraints and other types of strategies are applicable to the systems and methods described herein, and can be used to determine how a task of a task node is executed.

In another example aspect, workflow attributes 320 are specified or selected by the user. Workflow attributes include one or more constraints, or one or more strategies, or both, that are applicable to the entire workflow 300. For example, a workflow constraint for total time is specified by the user to indicate the maximum time for completing processing the tasks of the entire workflow.

In another specific example of a workflow, a task node labelled as a quantum node includes a constraint to run on a single-core virtual machine (sometimes called a small machine) with access to a quantum device. Another task node in the same workflow that is labelled as a machine learning node includes a constraint to run on a machine with a GPU with adequate memory and compute. Another task node in the same workflow that is labelled as an analytical node includes a to run on a machine with adequate memory and compute, but does not require a GPU. Another task node in the same workflow is labelled as a report node and includes the constraint to run on a single-core virtual machine (or some other type of a computing device with a low amount of CPU and memory resources). These different task nodes are linked together through edges to form a workflow. For example, the output of the quantum node is the input of the machine learning node; the output of the machine learning node is the input of the analytical node; and the output of the analytical node is the input to the report node.

The workflow data, including the executable instructions, constraints, and, if selected or defined, any strategies, are stored on the user machine 101 and the dispatcher server system 102.

As will be discussed further, the code or executable instructions from the user machine 101 is not transmitted to the scheduler server system 103. In this way, the code or executable instructions of the workflow remain secure.

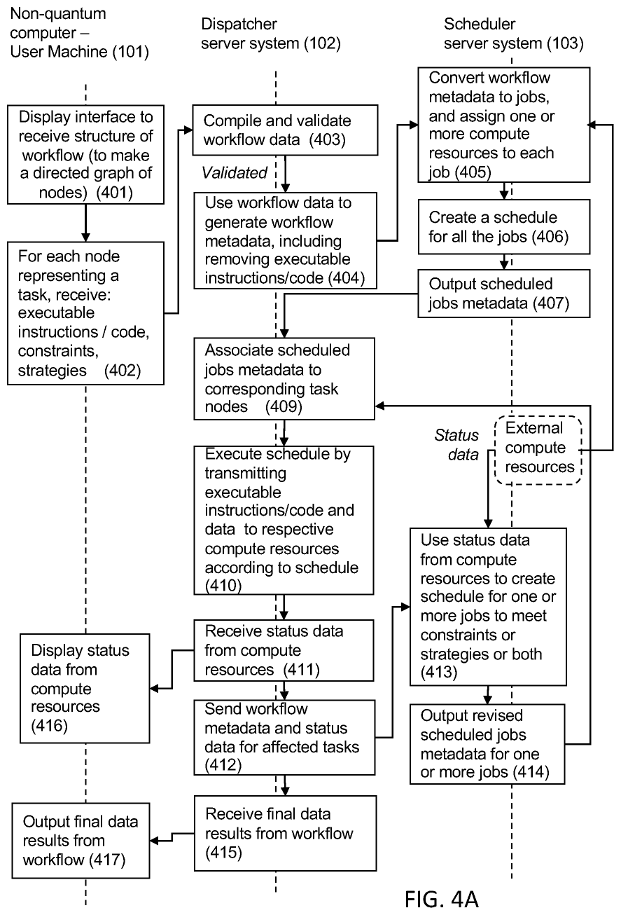

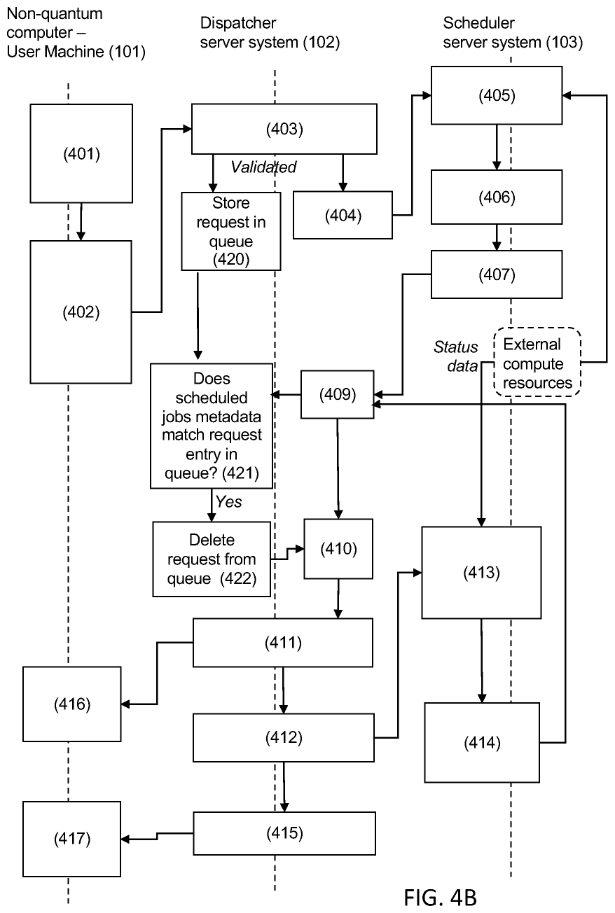

Turning to FIG. 4A, an example computing process is provided for scheduling and controlling computing resources to execute a workflow.

Block 401: The user machine 101 displays an interface to receive structure of workflow, for example, to make a directed graph of task nodes.

Block 402: The user machine 101 receives, for each task node, executable instructions, or code. The user machine further receives, for each task node, one or more constraints, or one or more strategies, or both constraints and strategies. The combination of the directed graph of task nodes and the data associated with each node forms a workflow data.

The user machine 101 sends the workflow data to the dispatcher server system 102.

Block 403: The dispatcher server system 102 compiles and validates the workflow data. For example, validation includes validating one or more given constraints are feasible.

An example validation rule includes: does the code format or code language of the user's task match a code format or code language pre-associated with the selected compute hardware type?

In another example of validation, if the user submits constraints or capabilities for a particular task node, and the dispatcher server system determines that a given constraint or capability is unsupported by the APIs or plugins of the executor module, then a validation error is provided, including sending an error message to the user machine 101 identifying which APIs or plugins are unavailable. In another example of validation, the dispatcher server system determines if the output data type of a preceding task node matches the input data type of a subsequent and connected task node, whereby the output data the preceding task node is the input data of the subsequent task node. Other types of validation computations can be used with the systems and methods described herein.

In another example aspect, the validation process at block 403 further includes compiling the workflow data. The compiling process includes, for example, optimizing the code. For example, a quantum circuit is compiled and optimized to potentially reduce the number of quantum gates, thereby generating a smaller circuit that is equivalent to the original circuit. The validation process is run on the smaller circuit.

While the dispatcher server system 102 is shown in FIG. 4A as executing validation computations, in another example aspect, the user machine 101, alternatively or in addition, executes validation computations. In another example aspect, the scheduler server system 103, alternatively or in addition, executes validation computations. Furthermore, validation computations can be executed at different stages of creating the workflow and scheduling the workflow.

After the dispatcher server system 102 validates the workflow data, then the process proceeds to block 404. If the workflow data is determined by the dispatcher server system 102 to have validation errors, these errors are communicated back to the user machine 101 for the user to address.

Block 404: The dispatcher server system uses the workflow data to generate workflow metadata. This process of creating workflow metadata includes removing the executable instructions or code. In particular, the executable instructions or code is not sent to the scheduler server system. In another example aspect, other identifying data, such as the name of the task, is removed and replaced with generics IDs, so as to further obfuscate the function. Mappings between the obfuscated data in the workflow metadata and the actual data of the workflow are stored in memory 217 on the dispatcher server system.

The workflow metadata includes data that identifies the relationship and sequence amongst tasks, which can be used to construct a directed graph of task nodes, which identifies the relationship and sequence amongst tasks. The workflow metadata also includes constraint data associated with each task node, and, if selected or defined, strategy data for each task node.

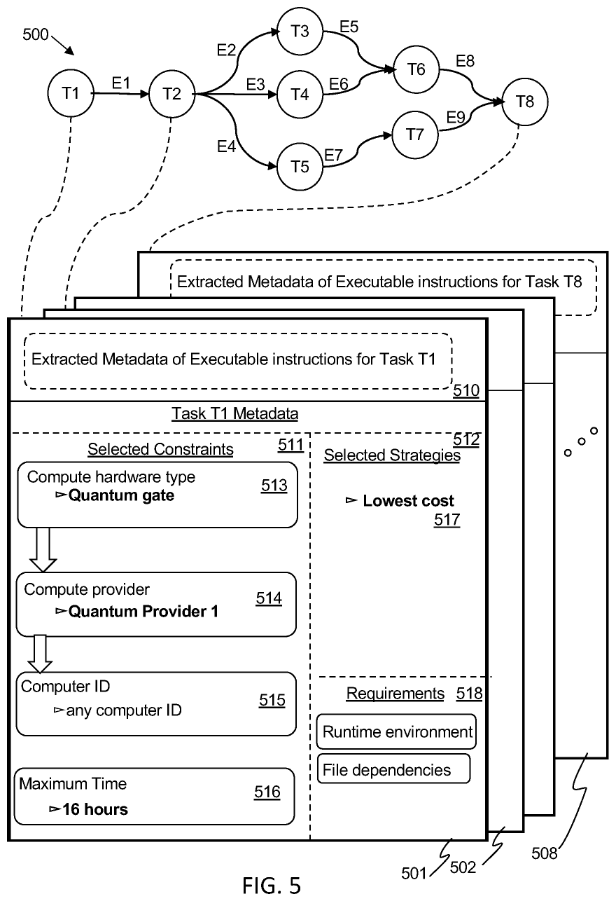

Turning briefly to FIG. 5, an example of the workflow metadata is shown, carrying on with the example shown in FIG. 3. The metadata includes information to construct a directed graph 500 of the tasks T1, T2, . . . , T8, and the relationship edges E1, E2, . . . , E9. Each task node has associated metadata. For example, the task node T1 has associated metadata 501. The task node T2 has the associated metadata 502. The task node T8 has the associated metadata 508.

In the example of the metadata 501 of the task T1, it includes extracted metadata of the executable instructions or code of T1 510. The extracted metadata of a task's executable instructions or code includes, for example, information about the code without revealing the full contents of the code. For example, the code is a quantum circuit, and the extracted metadata of the quantum circuit includes the number of quantum gates and the number of qubits in the quantum circuit. In another example, the code is written for a classical computer, and the extracted metadata includes the number of parallel computational threads in the code. In an alternative example, no metadata about the executable instructions or code of a task is included in the workflow metadata sent to the scheduler server system.

The metadata 501 also includes constraints 511 that were selected or defined by the user. These constraints include the computer hardware type 513 is a quantum gate computer; the computer provider type 514 is Quantum Provider 1; the computing device ID 515 is any computing device ID that is available; and that the maximum time for the computation 516 of this task T1 is 16 hours. The metadata 501 also includes one or more strategies 512 selected or defined by the user, which in this example is a lowest cost strategy 517. The metadata further includes the one or more requirements 518 specified by the user.

The metadata 502 associated with task T2 can be different from the metadata 501 associated with task T1.

Turning back to FIG. 4, the workflow metadata is sent from the dispatcher server system 102 to the scheduler server system 103.

Block 405: The scheduler server system converts the workflow metadata to jobs. Each job is assigned to one or more compute resources. In particular, based on the metadata of a task, the scheduler identifies the compute provider and the compute provider's computing device, and creates a job data object using the same information. In an example aspect, a job data object is a data object that holds job information including the computing resource to be used, parameters for the computing resource when executing the code or the quantum task of the task node, and metrics. In an example aspect, metrics include heuristic metrics which are estimations of a cost, quality, or other values that could influence the scheduling decision. In another example aspect, a metric in the job information includes a schedule quality value that is the estimated aggregated quality of the schedule relative to other potential schedules. The schedule quality value, for example, is a word or a number assigned by the scheduler server to the job data object.

In an example aspect, multiple job data objects are created for the same task. For example, the scheduler creates a first job with the compute provider IBMQ and a second job with a different compute provider IonQ for the same quantum compute task. The second job is a backup job should the compute provider for the first job be unavailable to execute the first job at the desired time. The scheduler server system or the dispatcher server system decides which one or more of the job data objects for the same task node should be executed. For example, the job data object with the highest schedule quality value is selected. Alternatively, two job data objects for the same task node are executed for redundancy.

In an example aspect, the scheduler server system obtains status data from one or more external computing resources to determine the estimated queue times, the availability of computing resources, and any other information that could affect the allocation of a given task to a given computing resource.

Block 406: The scheduler server system creates a schedule for all the jobs. For example, the scheduler server system generates a data file that includes the tasks of the workflow, including the specified job data objects for each task. In an example aspect, the scheduled job metadata does not include future timing information of ‘when’ a given task is to be executed. The scheduled jobs metadata specifies the ‘what’ and the ‘where’ of the task allocation.

In another example aspect, one form of the scheduled jobs metadata is a static schedule, and another form of the scheduled jobs metadata is a just-in-time schedule.

In the static-schedule form, the workflow metadata is submitted to the scheduler server system and the returned scheduled jobs metadata is executed as-is. There are no additional calls made from the dispatcher server system to the scheduler server system. For example, in the static-schedule form, the process shown in FIG. 4 does not include the operations specified at blocks 411, 412, 413, and 414. Instead, the process proceeds from block 410 to block 415. This static-schedule form is less data and processing intensive and uses less communication to the scheduler server system, which may incur less cost.

In the just-in-time form, the dispatcher server system makes additional calls to the scheduler server system after the workflow has been partially completed. The portion of the workflow which has completed will update constraints, e.g., cost and time elapsed are deducted from the original user-specified constraints, or a new queue-time estimate is provided. Then the uncompleted portion is re-scheduled using the updated constraints. The advantage here is that the original constraints may be better satisfied, especially when the workflow budget is much larger than the cost of additional API calls for just-in-time scheduling.

Block 407: The scheduler server system outputs the scheduled jobs metadata of the jobs. The scheduler server system 103 sends the scheduled jobs metadata to the dispatcher server system 102.

Block 408: The scheduler server system then deletes the workflow metadata and the corresponding scheduled jobs metadata.

Schedules are not stored in the sense that once a schedule is returned, task-specific metadata (e.g., number of cores, strategy) is deleted from the scheduling server, and the schedule itself is also deleted. In other words, the workflow metadata and the related scheduled jobs metadata are erased from the memory of the scheduler server system. Some metadata, e.g., quantum queue times or solution qualities, may be aggregated to improve heuristics, but it is stripped of any identifying information. The identities of workflows are not stored on the scheduling server system and, therefore, are not tied to any of the heuristics data.

Block 407: The scheduler server system extracts schedule metadata of the jobs. This schedule metadata of jobs includes a task node identifier and one or more parameters associated with each task node identifier. In a further example aspect, the schedule metadata of jobs also include one or more metrics are associated with each task node identifier.

The scheduler server system 103 sends the scheduled jobs metadata to the dispatcher server system 102.

Block 409: The dispatcher server system 102 identifies the job metadata specific to each task in the scheduled jobs metadata, and then associates the job metadata, which is specific to each task, to corresponding task nodes in the workflow data. For example, job metadata for task T1 is stored in association with the task T1 in the workflow. In this way, when the executor module 222 executes the task T1, the executor module 222 will use the job metadata for task T1 to contact and use the specified computing resource.

Block 410: The dispatcher server system 102 executes the schedule by transmitting executable instructions/code and data to respective compute resources, such as the computing resources 104, 105, 106, 107,108 according to the schedule of jobs.

In an example aspect, using a just-in-time approach, status updates can be received to update the schedule of jobs. This is shown in blocks 411 to 414.

Block 411: The dispatcher server system 102 receives status data from the compute resources.

This status data is transmitted to the scheduler server system 103. Alternatively, or in addition, the scheduler server system 103 also receives status updates from the compute resources through other communication channels.

Block 412: The dispatcher server system determines if the status updates show a change in timing or availability. For example, is there a delay in availability? Has a computing resource been compromised or become unavailable? If not, there no change in timing or availability, the schedule is kept. However, if there is a change, then the dispatcher server system sends the workflow metadata and any revisions to the attributes (e.g., attributes or strategies, or both) to the scheduler server system.

Alternatively, the dispatcher server system does not execute a comparison to determine if there is a change in status. Instead, the dispatcher server system automatically sends workflow metadata and status data to the scheduler server system after receiving a status update.

Block 413: The scheduler server system uses the workflow metadata and the status data to assign one or more computing resources to each task. A revised job data object, which includes the assigned computing resource and any parameters, is generated to meet the one or more constraints, or the one or more strategies, or both, as applicable. The processes of blocks 405 and 406 are repeated at block 413, but using the newly received workflow metadata and the status data.

It will be appreciated that the scheduler server system does not have stored record of the previous workflow metadata nor the corresponding scheduled jobs metadata that it computed. Therefore, even though the same dispatcher server system is sending status updates and the same or similar workflow metadata again, the scheduler server system processes the workflow metadata and the status updates as a new and separate instance.

Block 414: The scheduler server system outputs the revised scheduled jobs metadata for the one or more jobs.

This revised scheduled jobs metadata is transmitted to the dispatcher server system 102, and the process of executing the schedule is carried on using the revised scheduled jobs metadata. The process from block 414 continues to block 409 and the process at the dispatcher server system is repeated. The process of obtaining an updated or revised scheduled jobs metadata can be repeated any number of times. In an example aspect, the number of call made

After outputting the revised scheduled jobs metadata, the workflow metadata and the related revised scheduled jobs metadata are deleted (block 408).

Block 416: In an example aspect, the status data is also transmitted to the user machine 101 for display to the user.

Block 415: After the tasks in the workflow have been executed, the dispatcher server system 102 receives the final data results.

In an example aspect, this data is transmitted to the user machine 101 and then outputted on the user machine 101 (block 417).

Turning to FIG. 4B, a similar example embodiment is shown, bur further includes storing incoming requests from the workflow into the queue 250 (block 420). After the requests have been addressed, such as by associating scheduled jobs metadata to the corresponding task nodes (block 409), the dispatcher server system determines if the scheduled jobs metadata matches a request entry in the queue (block 421). If so, the dispatcher server system deletes the request from the queue (422). It will be appreciated that if the dispatcher server system fails (e.g., power failure, software failure, data connection failure, etc.), then the list of the already submitted requests that have not been processed remain on the queue 250. When the dispatcher server system re-activates or recovers from the failure, it can resume with processing the requests that remain on the queue 250. In other words, the queue is also used to track the progress of which requests have been processed, and which have not yet been processed.

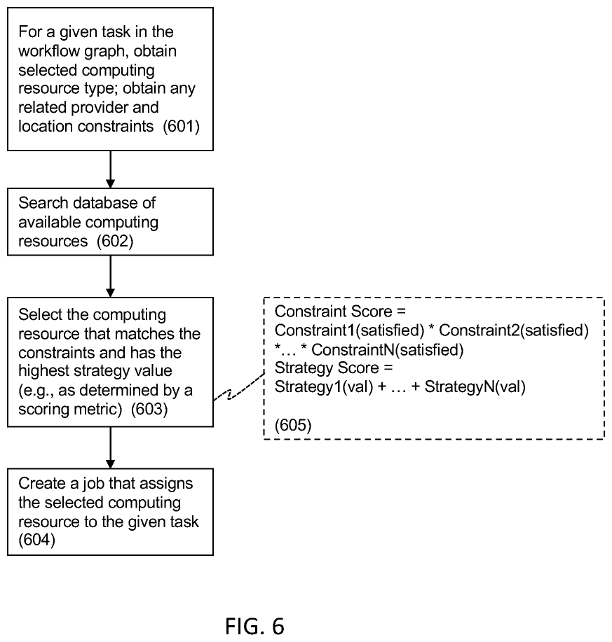

Turning to FIG. 6, an example process is provided for executing block 406. In particular, an example of executable instructions is provided for creating a schedule of the jobs.

These executable instructions are executed by the scheduler server system 103.

Block 601: For a given task (also called a task node) in the workflow graph, the scheduler server system obtains the selected computing resource type from the workflow metadata. The scheduler system also obtains any related provider and location constraints from the workflow metadata.

Block 602: The scheduler server system searches a database of available computing resources.

Block 603: For the given task, the scheduler server system selects the computing resource that matches the constraints and has the highest strategy value. In an example embodiment, a scoring metric is used to determine a match.

In an example aspect, as shown at block 605, there are several different constraints identified as Constraint1 to ConstraintN, where N is a natural number. When a constraint is satisfied, the value assigned to the constraint parameter is 1, and when it is not satisfied the value assigned to the constraint parameter is 0. For example, if the constraint that a compute hardware type is a quantum gate device, and there is a matching service provider that provides this quantum gate device, then the value is 1 for this constraint. A constraint score is computed by taking a product of the constraint parameters. For example, the constraint score=Constraint1(satisfied)*Constraint2(satisfied) * . . . * ConstraintN(satisfied). If any of the constraints are not satisfied, then the score is 0. If all the constraints are satisfied, then the score is 1. The scheduler server system selects compute providers for a job with a constraint score of 1.

If at least one compute provider satisfies leads to a constraint score of 1, then the scheduler server system can proceed with computing a schedule for other tasks. However, if the scheduler server system computes a constraint score equal to 0 for all available compute resource types and compute resource providers, which may include several options or only a single option, then the scheduler server system responds by automatically returning an error message associated with the given task. The scheduler server system further responds by stopping other computations associated with scheduling other tasks in the same workflow.

In situations where there are multiple compute resource types and compute resource providers that have a constraint score of 1, which indicates multiple eligible job options, then the scheduler server system uses a strategy score to select the most optimal compute resource and corresponding compute provider and computing resource type. In this way, the eligible computing resources and their compute providers can be sorted according to ability to match the desired strategy or strategies.

One or more strategies are identified as Strategy1 to StrategyN, where N is a natural number. The value of a given strategy parameter can vary based on how much the given parameter is satisfied. For example, a strategy parameter for faster speed means that a computing resource that has the faster computing capability will have a higher strategy score compared to another eligible computing resource with a slower computing capability. In another example, a strategy parameter for lower cost means that a computing resource with a lower cost will have a higher strategy score compared to another eligible computing resource with a higher cost. The values of the strategy parameters are normalized and added together to compute an overall strategy score. The computing resource and corresponding computing provider, which has a constrain score of 1, and that provides the highest overall strategy score is labeled by the scheduler server system as the optimal match for the given job. Other eligible options are sorted according to their strategy score.

Block 604: After selecting the computing resource, the scheduler server system creates a job that is an assignment of the selected computing resource to the given task

Below is an example embodiment of code created using the user machine 101 to generate a workflow. As noted above when discussing FIG. 3, the workflow created by the user can be in a graphical format, a typographical format, or a combination of both. In the example embodiment below, the workflow is shown in a typographical format. For example, the user types in the following code into a typographical interface on their user machine, such as via a keyboard, a form of input hardware 205.

### Example Embodiment of Workflow Code Created by User:

```
    from workflow_system import task, workflow
    import pennylane as qml
    @task(quantum=False, num_cpu=1, memory=1024, budget=15)
    def task_add(x, y):
      return x + y
    @task(quantum=False, num_cpu=4, budget=10)
    def task_subtract(x, y):
      return x − y
    @task(quantum=True, backend=“gate”, num_cpu=4, budget=40,
strategy=“high_quality”)
    def task_quantum(x):
      device = qml.device(‘workflow_system.device’, wires=5)
      @qml.qnode(device)
      def circuit(x):
        a, b, c, d = x
        qml.RX(a, wires=0)
        qml.RY(b, wires=1)
        qml.CNOT(wires=(0, 1))
        qml.SWAP(wires=(0, 3))
        qml.Toffoli(wires=(2, 3, 4))
        qml.RX(c, wires=2)
        qml.CZ(wires=(3, 4))
        qml.CRZ(d, wires=(1, 2))
        measurements = (
          qml.expval(qml.PauliZ(0)),
          qml.expval(qml.PauliZ(1)),
          qml.expval(qml.PauliZ(2)),
          qml.expval(qml.PauliZ(3)),
          qml.expval(qml.PauliZ(4)),
        )
        return measurements
  result = circuit(x)
  return result
@workflow(budget=80)
def work(a, b):
  g = task_add(x=a, y=b)
  h = task_subtract(x=g, y=5)
  i = task_quantum(x=h)
  return i
```

In the above example embodiment, three task nodes are defined by the user. These include the task_add node, the task_subtract node, and the task_quantum node.

The task_add node includes an adding function x+y, and it further includes the following user defined constraints: quantum=False, num_cpu=1, memory=1024, and budget=15. In other words, this task is a classical computing task that does not require quantum hardware devices. This task is to be executed by a computing device constrained to one central processing unit (CPU) and a memory capacity of 1024 megabytes; and the execution of the task is constrained to a cost of 15 cost units (e.g., 15 dollars).

The task_substract node includes a subtraction function x-y. The user defined constraints include: quantum=False, num_cpu=4, and budget=10.

The task_quantum node includes a classical computing component and a quantum computing component. The classical computing node, itself executed on a classical computing hardware system, runs the instructions needed to be sent to the quantum computer. For instance, the classical computing component (e.g., device=qml.device(‘workflow_system.device’, wires=5)) can initialize a quantum device and its circuit. The quantum task includes a quantum circuit of five qubit operations (e.g., denoted as wires), and a number of quantum gates. For example, qml.RX represents a RX gate on the qubit ‘0’ or wire=0, which is a rotation gate about the X-axis. For example, qml.CNOT is a controlled NOT gate spanning the qubits ‘0’ and ‘1’ (or wires=(0,1)). In another example, qml.Toffoli is a Toffoli gate, also called a controlled-controlled-not gate, that spans three qubits identified as ‘2’, ‘3’, and ‘4’ (or wires=(2,3,4)). The Toffoli gate has 3 qubit inputs and outputs; if the first two bits are both set to 1, it inverts the third bit, otherwise all bits stay the same. The quantum circuit also includes measurement devices for each of the five qubits. The task_quantum node also defines the attributes, which includes constraints and a strategy selected by the user. The constraints are: quantum=True, backend=“gate”, num_cpu=4, and budget=40. This means that this node is a quantum node and is constrained to gate-base quantum computing devices. For the classical computing device, which initiates the quantum computing, the classical computing device is constrained to a device having four CPUs or CPU cores. A strategy is “high_quality”, which means that the quantum computing device should pursue a high quality result. For example, the scheduler server system specifies parameters of a quantum computing device that will increase the quality of the results. Examples of such parameters include: the number of iterations executed by the quantum computing device, where a higher number of shots (e.g., iterations) produces a higher quality result; an operating temperature of the quantum computing device, where a lower temperature provides a higher quality result; adding an error mitigation part to a quantum circuit; and a noise specification of a quantum computing device, where less noise produces a higher quality result. In another example aspect, the scheduler server system selects a specific quantum computing device that is known to provide higher quality results (e.g., known by heuristics or by data specifications, or both). For example, a quantum device operator has a gate-based quantum computing device in a first city (e.g., London) and another gate-based quantum computing device in a second city (e.g, Vancouver), and the scheduler server system selects the gate-based quantum computing device in the second city since it is known to provide higher quality results.

The workflow object (e.g., “@workflow”) defines a global budget constraint of 80 cost units. It also defines the workflow arguments (a,b) and how the task nodes are linked. For example, the output g of the task node task_add is an input into the task node task_subtract. The output h of the task node task_subtract is an input into the task node task_quantum.

In an example aspect, the user machine 101 processes the workflow code of the three tasks (task_add, task_substract, and task_quantum) to output the following example embodiment data. In particular, in the below example embodiment, the functions objects are a Base64 encoding of a pickled object. Base64 is a way to encode data into a printable string. Pickling means a process of serializing data objects, for example, into bit-stream objects. In this way, the functions and the arguments are encoded. Other processes for encoding the workflow code can be used.

In an example aspect, the workflow code of each task is encoded for data security. In another example aspect, the encoding reduces the data size for transmission. The dispatcher server system can decode it by doing the inverse operations (e.g., convert base64 to binary then unpickle). It will be appreciated that the decoding process can also vary to as appropriate to the encoding process.

### Example Embodiment of Encoded Workflow Sent to Dispatcher Server System:

```
{
  “nodes”:
  [
    {
      “name”: “task_add”,
      “args”:
      [ ],
      “attributes”:
      {
        “quantum”: false,
        “num_cpu”: 1,
        “memory”: 1024,
        “budget”: 15
      },
      “id”: 0,
      “kwargs”:
      {
        “x”: 48,
        “y”: 12
      },
      “function”:
      {
        “object”:
“gAWV8QEAAAAAAACMF2Nsb3VkcGlja2xlLmNsb3VkcGlja2xlllwNX2J1aWx
0aW5fdHlwZZSTllwKTGFtYmRhVHlwZZSFlFKUKGgCjAhDb2RlVHlwZZSFlF
KUKEsCSwBLAEsCSwJLQ0MlfAB8ARcAUwCUToWUKYwBeJSMAXmUhpS
MQC9Vc2Vycy9ub2xhbi9Xb3Jrc3BhY2UvbmltYnVzL2V4YW1wbGVzL3Njcml
wdHMvcGF0ZW50X2V4YW1wbGUucHmUjAh0YXNrX2FkZJRLBUMCAAKU
KSl0lFKUfZQojAtfX3BhY2thZ2VfX5ROjAhfX25hbWVfX5SMCF9fbWFpbl9fllw
lX19maWxlX1+UaA51Tk5OdJRSllwcY2xvdWRwaWNrbGUuY2xvdWRwaWN
rbGVfZmFzdJSME19mdW5jdGlvb19zZXRzdGFOZZSTlGgZfZR9lChoFWgPjAx
fX3F1YWxuYW1lX1+UaA+MD19fYW5ub3RhdGlvbnNfX5R9llwOX19rd2RlZm
F1bHRzX1+UTowMX19kZWZhdWx0c19flE6MCl9fbW9kdWxlX1+UaBaMB19f
ZG9jX1+UTowLX19jbG9zdXJlX1+UTowXX2Nsb3VkcGlja2xlX3N1Ym1vZHVs
ZXOUXZSMC19fZ2xvYmFsc19flH2UdYaUhllwLg==”,
        “py_version”: “3.8.10”
      }
    },
    {
      “name”: “task_subtract”,
      “args”:
      [ ],
      “attributes”:
      {
        “quantum”: false,
        “num_cpu”: 4,
        “budget”: 10
      },
      “id”: 1,
      “kwargs”:
      {
        “y”: 5
      },
      “function”:
      {
        “object”:
“gAWV9gEAAAAAAACMF2Nsb3VkcGlja2xlLmNsb3VkcGlja2xlllwNX2J1aWx
0aW5fdHlwZZSTllwKTGFtYmRhVHlwZZSFlFKUKGgCjAhDb2RlVHlwZZSFlF
KUKEsCSwBLAEsCSwJLQ0MlfAB8ARgAUwCUToWUKYwBeJSMAXmUhpS
MQC9Vc2Vycy9ub2xhbi9Xb3Jrc3BhY2UvbmitYnVzL2V4YW1wbGVzL3Njcml
wdHMvcGF0ZW50X2V4YW1wbGUucHmUjA10YXNrX3N1YnRyYWN0lEsKQ
wlAApQpKXSUUpR9lCiMC19fcGFja2FnZV9flE6MCF9fbmFtZV9fllwlX19tYWl
uX1+UjAhfX2ZpbGVfX5RoDnVOTk50lFKUjBxjbG91ZHBpY2tsZS5jbG91ZHB
pY2tsZV9mYXN0llwSX2Z1bmN0aW9uX3NldHN0YXRllJOUaBl9lH2UKGgVa
A+MDF9fcXVhbG5hbWVfX5RoD4wPX19hbm5vdGF0aW9uc19flH2UjA5fX2t
3ZGVmYXVsdHNfX5ROjAxfX2RlZmF1bHRzX1+UTowKX19tb2R1bGVfX5Ro
FowHX19kb2NfX5ROjAtfX2Nsb3N1cmVfX5ROjBdfY2xvdWRwaWNrbGVfc3
VibW9kdWxlc5RdllwLX19nbG9iYWxzX1+UfZR1hpSGUjAu”,
        “py_version”: “3.8.10”
      }
    },
    {
      “name”: “task_quantum”,
      “args”:
      [ ],
      “attributes”:
      {
        “quantum”: true,
        “backend”: “gate”,
        “num_cpu”: 4,
        “budget”: 40,
        “strategy”: “high_quality”
      },
      “id”: 2,
      “kwargs”:
      { },
      “function”:
      {
        “object”:
“gAWVXwQAAAAAAACMF2Nsb3VkcGlja2xlLmNsb3VkcGlja2xlllwNX2J1aW
x0aW5fdHlwZZSTllwKTGFtYmRhVHlwZZSFlFKUKGgCjAhDb2RlVHlwZZSFl
FKUKEsBSwBLAEsESwRLQ0MsdABqAWQBZAJKA40CfQF0AKACfAGhAW
QEZAWEAlMBfQJ8AnwAgwF9A3wDUwCUKE6MDW5pbWJ1cy5kZXZpY2W
USwWMBXdpcmVzllWUaAgoSwFLAEsASwZLCUtTQ8J8AFwEfQF9An0DfQ
R0AGoBfAFKAWQCjQlBAHQAagJ8AmQDZAKNAgEAdABqA2QEZAKNAQE
AdABqBGQFZAKNAQEAdABqBWQGZAKNAQEAdABqAXwDZAdkAo0CAQ
B0AGoGZAhkAo0BAQB0AGoHfARKCWQCjQlBAHQAoAh0AKAJZAGhAaEB
dACgCHQAoAlkA6EBoQF0AKAldACgCWQHoQGhAXQAoAh0AKAJZAqhAa
EBdACgCHQAoAlkC6EBoQFmBX0FfAVTAJQoTksAaAxLAUsASwGGlEsAS
wOGlEsCSwNLBleUSwJLA0sEhpRLAUsChpRLA0sEdJQojANxbWyUjAJSW
JSMAlJZllwEQ05PVJSMBFNXQVCUjAdUb2Zmb2xpllwCQ1qUjANDUlqUjAZl
eHB2YWyUjAZQYXVsaVqUdJQojAF4llwBYZSMAWKUjAFjllwBZJSMDG1lY
XN1cmVtZW50c5R0llxAL1VzZXJzL25vbGFuL1dvcmtzcGFjZS9uaW1idXMvZ
XhhbXBsZXMvc2NyaXB0cy9wYXRlbnRfZXhhbXBsZS5weZSMB2NpcmN1a
XSUSxNDlAACDAEOAQ4BDAEMAQwBDgEMAQ4DDgEOAQ4BDgEO+wQ
HlCkpdJRSllwddGFza19xdWFudHVtLjxsb2NhbHM+LmNpcmN1aXSUdJRoFl
wGZGV2aWNlllwFcW5vZGWUh5QoaB9oLWgnjAZyZXN1bHSUdJRoJowMd
GFza19xdWFudHVtlEsPQwoAAg4CCAEKFAgClCkpdJRSlH2UKlwLX19wY
WNrYWdlX1+UTowlX19uYW1lX1+UjAhfX21haW5fX5SMCF9fZmlsZV9flGgm
dU5OTnSUUpSMHGNsb3VkcGlja2xlLmNsb3VkcGlja2xlX2Zhc3SUjBJfZnVu
Y3Rpb25fc2V0c3RhdGWUk5RoPH2UfZQoaDhoMowMX19xdWFsbmFtZV9fl
GgyjA9fX2Fubm90YXRpb25zX1+UfZSMDl9fa3dkZWZhdWx0c19flE6MDF9fZ
GVmYXVsdHNfX5ROjApfX21vZHVsZV9flGg5jAdfX2RvY19flE6MC19fY2xvc3
VyZV9flE6MF19jbG91ZHBpY2tsZV9zdWJtb2R1bGVzlF2UaACMCXN1Ymltc
G9ydJSTllwPcGVubnlsYW5lLnFub2RlllWUUpRhjAtfX2dsb2JhbHNfX5R9lGg
UaE2MCXBlbm55bGFuZZSFlFKUc3WGllZSMC4=“,
        “py_version”: “3.8.10”
      }
    }
  ],
  “links”:
  [
    {
      “variable”: “x”,
      “source”: 0,
      “target”: 1
    },
    {
      “variable”: “x”,
      “source”: 1,
      “target”: 2
    }
  ],
  “attributes”:
  {
    “budget”: 80
  }
}
```

The encoded workflow data (as per the above example) is sent to the dispatcher server system 102. After receiving the encoded workflow data, the dispatcher server system then extracts workflow metadata from the encoded workflow data and uses the same to create a workflow metadata file. In particular, sensitive information such as the functions, code, and arguments are removed from the encoded workflow data. In other words, this sensitive data is not present in the workflow metadata. An example embodiment of the workflow metadata for the three tasks is shown below.

### Example Embodiment of Workflow Metadata Inputted to Scheduler Server System:

```
{
  “nodes”:
  [
    {
      “attributes”:
      {
        “quantum”: false,
        “num_cpu”: 1,
        “memory”: 1024,
        “budget”: 15
      },
      “id”: 0
    },
    {
      “attributes”:
      {
        “quantum”: false,
        “num_cpu”: 4,
        “budget”: 10
      },
      “id”: 1
    },
    {
      “attributes”:
      {
        “quantum”: true,
        “backend”: “gate”,
        “num_cpu”: 4,
        “budget”: 40,
        “strategy”: “high_quality”
      },
      “id”: 2
    }
  ],
  “links”:
  [
    {
      “source”: 0,
      “target”: 1
    },
    {
      “source”: 1,
      “target”: 2
    }
  ],
  “attributes”:
  {
    “budget”: 80
  }
}
```

The above example shows the workflow metadata is organized by nodes data objects, links data objects, and attributes data objects that are applicable to the entire workflow. Within the nodes data objects, each task node is identified by an identifier or ID and is associated with one or more attributes. As noted above, attributes include a constraint or a strategy, or both.

The above example of workflow metadata inputted into the scheduler server system includes three task nodes. The task node with ID “0” corresponds to the task_add node; the task node with ID “1” corresponds to the task_subtract node; and the task node with ID “2” corresponds to the task_quantum node. The names of the task nodes are replaced in with generic IDs, such as numerals, to hide the nature or function of each task. The mappings between the actual task node names, arguments, and functions, and the generic IDs and related workflow metadata are stored in memory on the dispatcher server system 102. The attributes of each task are carried over into the workflow metadata.

Some of the links data objects from the above example are explained in detail as follows. The links data objects define the edges between the task nodes. A links data object defines a source “0” and a target “1”, which means that the task node with the ID “0” outputs data to the task node with the ID “1”. Another links data object defines a source “1” and a target “2”, which means the task node with the ID “1” outputs data to the task node with the ID “2”. The links data objects are used to define the interconnections (also called edges) between the task nodes that form the workflow.

Some of the attributes data objects from the above example apply to the combination of the task nodes that form the entire workflow. For example, an attributes data object specifying a constraint budget of 80 is metadata used by the scheduler server system to create a schedule for all the tasks that has a total cost within 80 cost units.

The scheduler server system 103 processes the above example embodiment of workflow metadata to generate and output scheduled jobs metadata. An example embodiment of scheduled jobs metadata for the three tasks, which is outputted by the scheduler server system and transmitted to the dispatcher server system, is provided below.

### Example Embodiment of Scheduled Jobs Metadata Outputted by Scheduler Server System:

```
{
  “nodes”:
  [
    {
      “backend”: “cluster1.qm1”,
      “backend_params”:
      {
        “quantum”: false,
        “slurm_flags”:
        {
          “cpus”: 1,
          “mem”: 1024
        }
      },
      “metrics”:
      {
        “estimated_queue_time”: “0-00:10:00”,
        “estimated_cost”: 10
      },
      “id”: 0
    },
    {
      “backend”: “aws-batch”,
      “backend_params”:
      {
        “quantum”: false,
        “batch_params”:
        {
          “vcpus”: 4,
          “memory”: “4gb”
        }
      },
      “metrics”:
      {
        “estimated_queue_time”: “0-00:00:30”,
        “estimated_cost”: 10
      },
      “id”: 1
    },
    {
      “backend”: “cluster1.qm1”,
      “backend_params”:
      {
        “quantum”: true,
        “slurm_flags”:
        {
          “cpus”: 4,
          “mem”: 4096
        }
      },
      “metrics”:
      {
        “estimated_queue_time”: “0-00:01:00”,
        “estimated_cost”: 6
      },
      “quantum_component”:
      {
        “backend”: “ibmq”,
        “backend_params”:
        {
          “device”: “ibmq-seattle-1”,
          “num_qubits”: 20,
          “num_shots”: 100,
          “depth_circuit”: 100
        },
        “metrics”:
        {
          “estimated_queue_time”: “0-00:20:00”,
          “estimated_cost”: 34,
          “estimated_solution_quality”: “good”
        }
      },
      “id”: 2
    }
  ],
  “schedule_quality”: 0.93
}
```

The above scheduled jobs metadata maintains the generic task node IDs “0”, “1”, and “2”. In another aspect, the scheduled jobs metadata does not include the links data objects. The links data objects, which are the edges between the task nodes, are not required in the output from the scheduler server system 103 since the dispatcher server system 102 already stores this data.

In the above example, the outputted metadata includes three node data objects that correspond to the three tasks in the workflow. Each node data object includes a task node ID, a backend value that specifies a computing hardware resource, parameters associated with the specified computing hardware resource, and optionally metrics.

For a given node data object that specifies a quantum computing hardware resource, the node data object includes a classical compute component and a quantum compute component. The classical compute component invokes or initiates the processing by the quantum computing hardware.

In the above example, the task node with the ID “0” specifies a HPC cluster computing hardware system. It also specifies parameters, including: the cluster computing is a non-quantum computing hardware type, and the cluster computing includes one CPU and 1024 megabytes of memory. The task node also includes metrics data, such as an estimate queue time of 10 minutes and an estimated cost of 10 cost units, which is within the budget constraint of 15 cost units. The metrics data is used by the dispatcher server system 102, for example, to ensure that the scheduled jobs are within the specified constraints.

The task node with the ID “1” specifies a cloud computing batch processing system, which is a non-quantum computing hardware resource. The parameters of the batch processing system include four CPUs and 4096 megabytes of memory. The metrics data includes metrics data, such as an estimate queue time of 30 seconds and an estimated cost of 10 cost units.

The task node with the ID “2” includes a classical component and a quantum component. The classical component specifies a cluster computing hardware system with the parameters including four CPUs and 4096 megabytes of memory. The associated metrics of the classical components are an estimated 10 minutes of queue time and an estimated cost of 6 cost units. The quantum component, which is initiated by the classical component, specifies a gate-based quantum computing hardware device, which is identified by a specific provider. The parameters of the quantum component include the quantum computing device ID or device name (which could be identifiable by location or a number, or some other indicator), the number of qubits of the quantum computing device (e.g., 20 qubits), the number of shots (e.g., 100 shots), and the depth of the quantum circuit (e.g., 100). The number of shots refers to the number of times a quantum circuit is executed or measured. The depth of quantum circuit refers to the number of time steps for the quantum operations making up the quantum circuit to run on the quantum computing device. The depth of the quantum circuit can also herein refer to the longest path in the quantum circuit, representing the number of gates to execute in that longest path. In the example provided, this means that the quantum device is going to execute the quantum circuit using a configuration of 20 qubits, 100 shots, and a depth of 100.

Turning to FIG. 7A, another example embodiment of the scheduled jobs metadata outputted by the scheduler server system is diagrammatically shown to highlight the difference between a quantum compute component and the classical compute component in Task 2, with reference numeral 701. Task 2 corresponds to the actual task node named “task_quantum” in the example embodiment above, but has been masked with a generic ID “2”. The classical component 702 defines the computing hardware device and parameters of a classical computing task, which are used to invoke or initiate the quantum computing task. The quantum component 703 defines the quantum computing hardware device and parameters of the quantum computing task.

FIG. 7B shows an example embodiment of the input 707 to the executor module 222 for Task 2 using several different data components, including the scheduled jobs metadata 701 which was described in FIG. 7A. The input 707 for Task 2 to the executor module 222 includes the combination of the Task 2 workflow metadata outputted by the scheduler server system 701, the Task 2's executable data (e.g., executable instructions or code, functions, data, and arguments) 705, and the configuration data for the specified computing hardware resources 706. The configuration data 706 includes credentials and endpoint address or identifier.

The executable data 705 includes, for example, the “@qml.qnode(device)” data object, which includes the quantum circuit “def circuit(x)”, as specified in the above example embodiment of the workflow code created by the user. The executable data 705 further includes requirements metadata, referencing any of runtime environment packages or toolkits, or other specifications. This executable data 705 is extracted by the dispatcher server system 102 from the encoded workflow data associated with “task_quantum”, which was sent to the dispatcher server system.

In an example aspect, the Task 2's executable data 705 is stored locally on the dispatcher server system 102, and the configuration data 706 is also stored locally on the dispatcher server system 102. In another example aspect, the executable data includes plugins or endpoints to the scheduled computing resource. For example, the executable data 705 also includes an API endpoint for the gate-based quantum computing device. For example, the quantum gate endpoint for the Task 2 is a network address, such as a uniform resource locator (URL), that enables an API to access the gate-based quantum computing device. In another example aspect, the configuration data is predefined by a system administrator or a user.

In another example embodiment, the configuration data 706 further includes credentials that facilitates computing resources (e.g., 104, 105, 106, 107, 108) to directly communicate with each other. For example, the credentials are used by two or more computing resources to establish a direct communication channel with each other to exchange data.

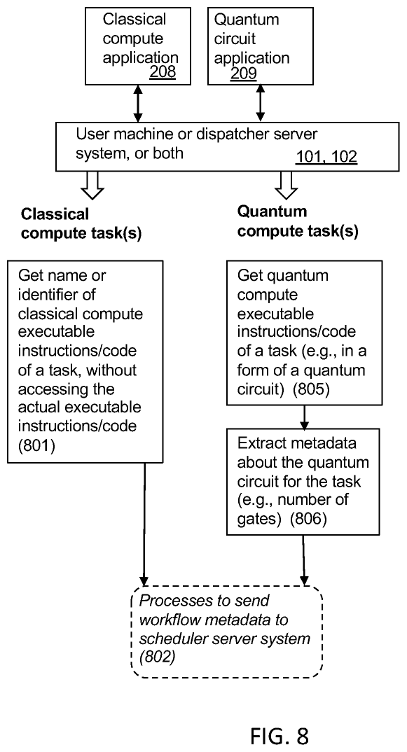

Turning to FIG. 8, an example embodiment of executable instructions is provided for the user machine 101 or the dispatcher server system 102, or both, processing a workflow that includes one or more tasks comprising code executed on classical computers and one or more tasks comprising quantum circuits executed on quantum device or computers. For example, code to be executed on classical computers is developed using the classical compute application 208, and a quantum circuit to be executed on a quantum device or quantum computer is developed using the quantum circuit application 209. In an example aspect, the dispatcher server system or the user machine compiles the code to optimize the code, such as reducing the number of quantum gates in a quantum circuit, or reduce the number of function calls in a classical software program. Other types of optimizations can be applied to classical software code or quantum circuit code.

At block 801, for classical computing tasks, the workflow application or the executor module obtains the name or the identifier of classical compute executable instructions/code of a task.

At block 802, the process proceeds with extracting and sending the workflow metadata to the scheduler server system 103. The workflow metadata excludes the actual executable instructions/code, as this data is purposely withheld from the scheduler server system.

At block 805, for quantum compute tasks, the user machine or the dispatcher server obtains quantum compute executable instructions/code of a task (e.g., in a form of a quantum circuit or some other form of a quantum task).

At block 806, the user machine or the dispatcher server system extracts metadata about the quantum circuit for the task (e.g., number of gates, problem size, requested quality of solution, and problem topology).

It will be appreciated that different types of metadata are extracted from the classical compute code compared the quantum compute code or circuit. Additional data about the quantum circuit or the quantum task is included in the metadata provided to the scheduler server system so that the scheduler server system can make a better selection of a quantum computing resource to execute the quantum task.

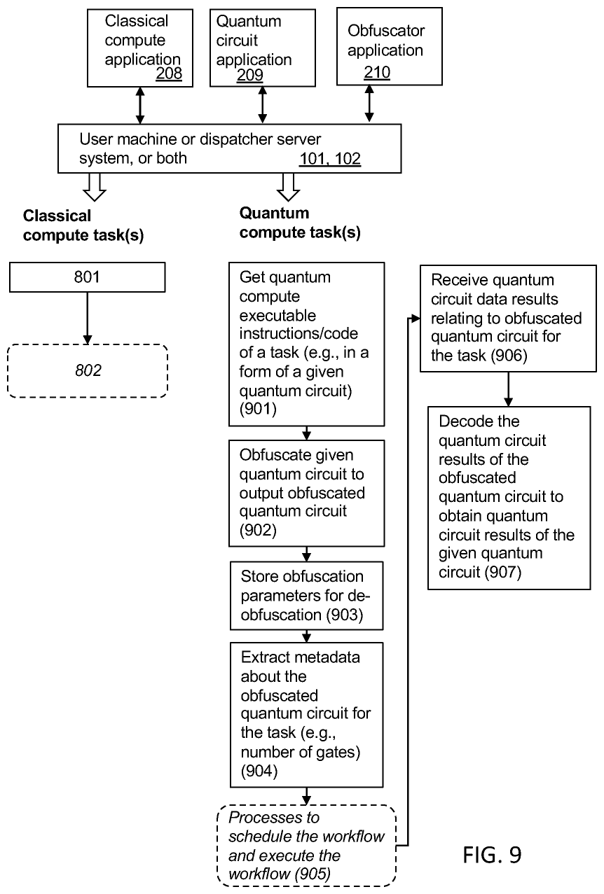

Turning to FIG. 9, another example embodiment is shown that includes additional processing steps for quantum circuit computations. In particular, an obfuscator application 210 is used to obfuscate a quantum circuit and decode the results of the obfuscated quantum circuit. The obfuscator application 210 can reside on the user machine 101 or the dispatcher server system 102, or both. In an example aspect, the quantum circuit is obfuscated before data about the quantum compute task is sent to the scheduling server system.

It will be appreciated the example in FIG. 9 refers to a quantum task in the form of quantum circuit. However, other forms of quantum tasks can be obfuscated by the obfuscator application and results of the obfuscated quantum task, as computed by a quantum computer hardware resource, can be decoded by the obfuscator application.

Block 901: The user machine or the dispatcher server system, or both, obtains quantum compute executable instructions/code of a task (e.g., in a form of a given quantum circuit).

Block 902: The user machine or the dispatcher server system, or both, obfuscates the given quantum circuit to output an obfuscated quantum circuit.

Obfuscation of a quantum circuit includes, for example, adding extra qubits to the quantum circuit. In another example, obfuscation includes generating decoy circuits to generate a set of quantum circuits that include the real quantum circuit and multiple decoy quantum circuits. Other currently known and future known computations for obfuscation can be used.

Block 903: The user machine or the dispatcher server system, or both, stores the obfuscation parameters for de-obfuscation.

Block 904: The user machine or the dispatcher server system, or both, extracts metadata about the obfuscated quantum circuit for the task (e.g., number of quantum gates).

Block 905: Processes to schedule the workflow and execute the workflow are executed using the scheduler server system and the dispatcher server system.

Block 906: The user machine or the dispatcher server system, or both, receives quantum circuit data results relating to obfuscated quantum circuit for the task.

Block 907: The user machine or the dispatcher server system, or both, decodes the quantum circuit results of the obfuscated quantum circuit to obtain quantum circuit results of the given quantum circuit.

In this way, the scheduler server system and the quantum compute device belonging to a third party do not access the original or real quantum circuit created by the user. The original or real quantum circuit remains secure and undisclosed.

In another example aspect, the scheduler server system 102 temporarily stores workflow metadata in memory 232. For example, after using the workflow metadata to generate and output the corresponding scheduled jobs metadata, the scheduler server system 102 deletes the workflow metadata and the corresponding scheduled jobs metadata from memory 232. By comparison, other workflow management computing systems store workflows, including versions of workflows and recurring workflows. Instead, the scheduler server system 103 temporarily stores the workflow metadata to generate the scheduled jobs metadata. After outputting the scheduled jobs metadata, the scheduler server system 103 deletes the workflow metadata and the corresponding scheduled jobs metadata. This improves security and reduces the computational workload on the scheduler server system.

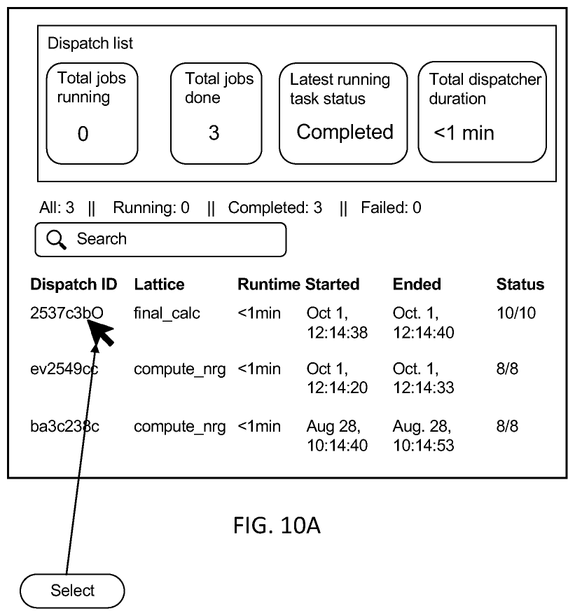

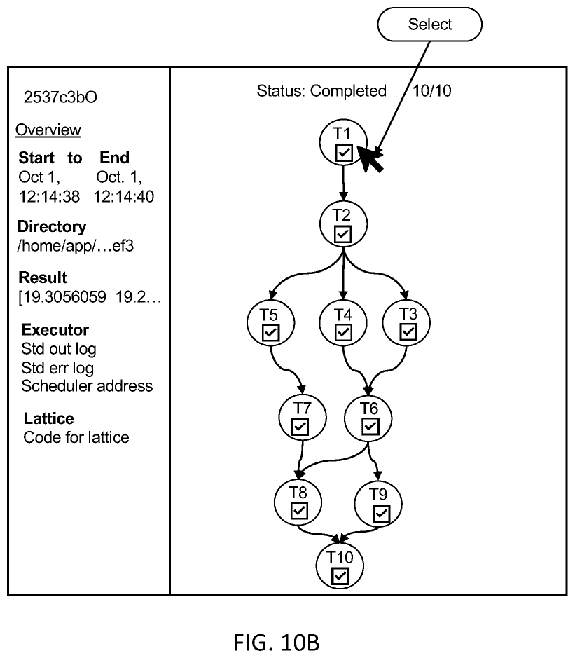

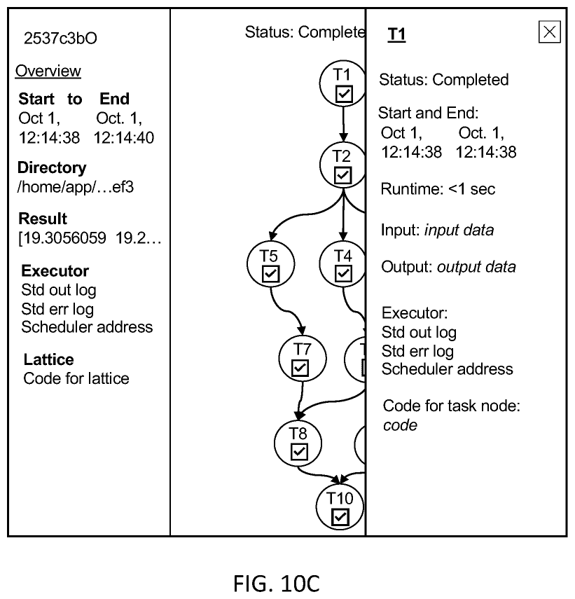

FIGS. 10A, 10B and 10C are example embodiments of screenshots of graphical user interfaces (GUI). In FIG. 10A, a portal of the workflow application is shown, which displays the total number of jobs currently running, the total number of workflows that have been completed, the status of the latest running tasks, and the total dispatcher duration. The portal also includes a search field, which receives input search terms to find one or more specific workflows. A listing of workflows is provided, each one identified with a dispatch ID. Associated with each workflow entry is a name of the lattice, the runtime, the start and end date, and the status. For example “10/10” refers to the lattice (also called the workflow) having ten tasks nodes and all ten task nodes have been executed.

A selection input is received on a given one of the workflow entries with the dispatch ID “2537c3bO”, which then causes the GUI of the portal to show detailed view of the given workflow shown in FIG. 10B. In particular, in FIG. 10B, the overview of the workflow includes the start and end time stamps, the directory address, the result, the logs associated with the execution of the workflow, and the code for the workflow (also called the lattice). FIG. 10B also includes the workflow shown as nodes, in this case ten nodes. An indicator, such as a checkbox, is displayed with each node which indicates that each node has been executed. A selection input on the node “T1” is detected in FIG. 10B, which then causes the GUI to display details about the node “T1”.

In FIG. 10C, the details of the node “T1” are shown, which include, that status, the start and end time stamp of the particular task of the node “T1”, the runtime, the input data, the output data, the one or more logs associated with executing the node T1, and the code specific to the node T1.

It will also be appreciated that the workflow application uses a first language to establish and form the workflows, but the execution of the tasks could be in one or more different computing languages for scripting and compiling. For example, the orchestration computing language for the workflows is in Python, while the code of the tasks within the workflow is in C++, Fortran, Julia, etc. or other different scripting languages and compiling languages.

Below are general example embodiments.

In an example embodiment, a hybrid computer system is provided comprising:
a dispatcher server system, a scheduler server system, a quantum computing system, and a classical computing system;
the dispatcher server system comprising a processor system and a memory system that extracts workflow metadata from a workflow project which comprises a plurality of tasks, and transmits the workflow metadata to the scheduler server system, wherein the workflow metadata comprises one or more constraints associated with each task of the plurality of tasks, the one or more constraints defining a computing resource attribute;
the scheduler server system comprising a processor system and a memory system that obtains the workflow metadata, generates a job schedule using the workflow metadata, and transmits metadata of the job schedule to the dispatcher server system, wherein the metadata of the job schedule comprises parameters specifying at least one computing resource associated with each task of the plurality of tasks; and
the dispatcher server system using the metadata of the job schedule and the workflow data to transmit code and data to the quantum computing system and the classical computing system according to a sequence defined by the workflow project.

In an example aspect, the quantum computing system comprises at least one of: a gate-based quantum computing device, a measurement based quantum computing device, a quantum annealing device, and a quantum inspired hardware device.

In another example aspect, the plurality of tasks comprises a quantum task, and the workflow metadata comprises a task data object corresponding to the quantum task; and, the task data object corresponding to the quantum task comprises a quantum constraint specifying a type of quantum computing device.

In another example aspect, the metadata of the job schedule comprises a job data object corresponding to the quantum task, and the job data object comprises: a specified quantum computing device to execute the quantum task, one or more parameters of the specified quantum computing device, and one or more metrics associated with the specified quantum computing device.

In another example aspect, the task data object corresponding to the quantum task comprises a classical computing component and a quantum computing component; the classical computing component comprises a classical constraint specifying a type of classical computing system to initiate the quantum task; and the quantum computing component comprises the quantum constraint.

In another example aspect, the workflow metadata comprises a plurality of task data objects corresponding to the plurality of tasks, and one or more data links between the plurality of task data objects specifying one or more input-output relationships between the plurality of task data objects.

In another example aspect, the metadata of the job schedule excludes the one or more data links between the plurality of task data objects.

In another example aspect, the plurality of tasks comprise the one or more constraints associated with each task of the plurality of tasks, at least one function associated with each task of the plurality of tasks, and at least one argument associated with each task of the plurality of tasks; and the dispatcher server system excludes the at least one function associated with each task of the plurality of tasks, and excludes the at least one argument associated with each task of the plurality of tasks, while extracting the workflow metadata.

In another example aspect, after the scheduler server system transmits the metadata of the job schedule to the dispatcher server system, the scheduler server system deletes the workflow metadata and the metadata of the job schedule from the memory system of the scheduler server system.

In another example aspect, the memory system of the dispatcher server system stores thereon a plurality of constraints in a hierarchical data tree structure, and the one or more constraints that are associated with each task of the plurality of tasks are selected from the plurality of constraints.

In another example aspect, a given selected constraint associated with a given task is a child constraint associated with a parent constraint in the hierarchical data tree structure, and the dispatcher server system automatically applies the parent constraint to the given task.

In another example embodiment, a computing system for scheduling computing resources is provided, comprising:
a non-transitory computer readable medium storing thereon at least executable instructions for a workflow application, the executable instructions comprising:
   receiving a plurality of task nodes that define a workflow project representable as a directed graph structure, each one of the plurality of task nodes comprising a computing task and one or more constraints corresponding to the computing task, the one or more constraints specifying at least a type of computing hardware resource to execute the computing task;
   generating workflow metadata from the workflow project, the workflow metadata comprising: a plurality of task data objects corresponding to the plurality of task nodes, each one of the plurality of task data objects comprising the one or more constraints extracted from the workflow project, and one or more data links between the plurality of task data objects specifying one or more input-output relationships between the plurality of task data objects;
   transmitting the workflow metadata file to a scheduler server system and, in response, receiving scheduled jobs metadata that comprises a plurality of job data objects corresponding to the plurality of task data objects, and the plurality of job data objects respectively specifies a plurality of computing devices to respectively execute the computing task of each of the plurality of task nodes; and
   combining at least the workflow project and the scheduled jobs metadata to transmit a given computing task of a given task node to a given specified computing device for execution, wherein the given computing task is obtained from the workflow project and the given specified computing device is obtained from the scheduled jobs metadata;
a processor system configured to execute the executable instructions; and
a communication system is configured to at least receive the workflow project, transmit the workflow metadata, receive the scheduled jobs metadata, and transmit the given computing task of the given task node to the given specified computing device.

In an example aspect, the plurality of task nodes comprises a quantum task node, which comprises a constraint specifying a quantum computing device and a computing task comprising a quantum task.

In another example aspect, the plurality of task data objects in the workflow metadata comprises a quantum task data object corresponding to the quantum task node; the plurality of job data objects in the scheduled jobs metadata comprises a quantum job data object; the quantum job data object comprises a classical component and a quantum component; the classical component comprises one or more parameters of a classical computing system; the quantum component comprises one or more parameters of a quantum computing device; and, the classical computing device is used to initiate the quantum computing device to execute the quantum task.

In another example aspect, the classical component further comprises one or more metrics associated with the classical computing system.

In another example aspect, the one or more metrics comprises at least one of an estimated queue time and an estimated cost to use the classical computing system to initiate the quantum computing device.

In another example aspect, the quantum component further comprises one or more metrics associated with the quantum computing device.

In another example aspect, the one or more metrics comprises at least one of an estimated queue time and an estimated cost to use the quantum computing device to execute the quantum task.

In another example aspect, the quantum computing device comprises at least one of: a gate-based quantum computing device, a measurement based quantum computing device, a quantum annealing device, and a quantum inspired hardware device.

In another example aspect, the quantum computing device comprises a gate-based quantum computing device and the quantum task comprises a quantum circuit.

In another example aspect, the plurality of task data objects in the workflow metadata comprises a quantum task data object corresponding to the quantum task node, and the quantum task data object comprises at least one of a number of quantum gates and a number of qubits of the quantum circuit.

In another example aspect, the computing task in each one of the plurality of task nodes is encoded, and the executable instructions further comprises decoding the computing task in each one of the plurality of task nodes.

In another example aspect, each one of the plurality of task nodes further comprises a task name, and the executable instructions further comprises: generating a mapping between a generic ID and the task name; labelling a corresponding task data object in the plurality of task data objects with the generic ID; and storing the mapping in the non-transitory computer readable medium.

In another example embodiment, a computing system for scheduling computing resources is provided, comprising:
a non-transitory computer readable medium storing thereon at least executable instructions of a scheduler application, the executable instructions comprising:
   receiving workflow metadata, the workflow metadata comprising: a plurality of task data objects, each one of the plurality of task data objects comprising one or more constraints specifying at least a type of computing hardware resource to execute an unspecified computing task, and one or more data links between the plurality of task data objects specifying one or more input-output relationships between the plurality of task data objects;
   creating a plurality of job data objects corresponding to the plurality of task data objects;
   assigning at least one computing system to the each one of the plurality of job data objects to execute, respectively, the unspecified computing task corresponding to the each one of the plurality of task data objects, and the at least one computing system satisfying, respectively, the one or more constraints corresponding to the each one of the plurality of task data objects;
   assigning one or more parameters associated with the each of the at least one computing system assigned to the each one of the plurality of job data objects;
   creating and transmitting a scheduled jobs metadata file comprising the plurality of job data objects, which comprises the at least one computing system assigned to the each one of the plurality of job data objects and the one or more parameters that are respectively associated therewith;
   deleting from the non-transitory computer readable medium workflow data and the scheduled jobs metadata file;
a processor system configured to execute the executable instructions; and
a communication system is configured to at least receive the workflow metadata and transmit the scheduled jobs metadata file.

In an example aspect, the plurality of task data objects in the workflow metadata comprises a quantum task data object and the executable instructions further comprise generating creating a quantum job data object that is part of the plurality of job data objects, and wherein: the quantum job data object comprises a classical component and a quantum component; the classical component comprises one or more parameters of a classical computing system; the quantum component comprises one or more parameters of a quantum computing device; and, the classical computing device is used to initiate the quantum computing device to execute an unspecified quantum task associated with the quantum task data object.

In another example aspect, the classical component further comprises one or more metrics associated with the classical computing system.

In another example aspect, the quantum component further comprises one or more metrics associated with the quantum computing device.

In another example aspect, the quantum computing device comprises at least one of: a gate-based quantum computing device, a quantum annealing device, and a quantum inspired hardware device.

In another example aspect, the quantum computing device comprises a gate-based quantum computing device and the quantum task comprises a quantum circuit.

In another example aspect, the plurality of task data objects in the workflow metadata comprises a quantum task data object that comprises one or more constraints specifying a quantum computing device, and the quantum task data object comprises at least one of a number of quantum gates and a number of qubits of the quantum circuit.

It will be appreciated that any module or component exemplified herein that executes instructions may include or otherwise have access to non-transitory computer readable media such as storage media, computer storage media, or data storage devices (removable and/or non-removable) such as, for example, memory chips, magnetic disks, optical disks. Computer storage media may include volatile and non-volatile, removable and non-removable media implemented in any method or technology for storage of information, such as computer readable instructions, code, processor executable instructions, data structures, program modules, or other data. Examples of computer storage media include random access memory (RAM), dynamic random access memory (DRAM), static random access memory (SRAM), read-only memory (ROM), solid-state ROM, electrically erasable programmable read-only memory (EEPROM), flash memory or other memory technology, or any other medium which can be used to store the desired information and which can be accessed by an application, module, or both. Any such computer storage media may be part of the servers or computing devices or nodes, or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

While certain example implementations of the disclosed technology have been described in connection with what is presently considered to be the most practical and various implementations, it is to be understood that the disclosed technology is not to be limited to the disclosed example implementations, but on the contrary, is intended to cover various modifications and equivalent arrangements included within the scope of the claims appended hereto.

1. A hybrid computer system comprising:
a dispatcher server system, a scheduler server system, a quantum computing system, and a classical computing system;
the dispatcher server system comprising a processor system and a memory system that extracts workflow metadata from a workflow project which comprises a plurality of tasks, and transmits the workflow metadata to the scheduler server system, wherein the workflow metadata comprises one or more constraints associated with each task of the plurality of tasks, the one or more constraints defining a computing resource attribute;
the scheduler server system comprising a processor system and a memory system that obtains the workflow metadata, generates a job schedule using the workflow metadata, and transmits metadata of the job schedule to the dispatcher server system, wherein the metadata of the job schedule comprises parameters specifying at least one computing resource associated with each task of the plurality of tasks; and
the dispatcher server system using the metadata of the job schedule and the workflow data to transmit code and data to the quantum computing system and the classical computing system according to a sequence defined by the workflow project.

2. The hybrid computing system of claim 1 wherein the quantum computing system comprises at least one of: a gate-based quantum computing device, a measurement based quantum computing device, a quantum annealing device, and a quantum inspired hardware device.

3. The hybrid computing system of claim 1 wherein the plurality of tasks comprises a quantum task, and the workflow metadata comprises a task data object corresponding to the quantum task; and, the task data object corresponding to the quantum task comprises a quantum constraint specifying a type of quantum computing device.

4. The hybrid computing system of claim 3 wherein the metadata of the job schedule comprises a job data object corresponding to the quantum task, and the job data object comprises: a specified quantum computing device to execute the quantum task, one or more parameters of the specified quantum computing device, and one or more metrics associated with the specified quantum computing device.

5. The hybrid computing system of claim 3 wherein the task data object corresponding to the quantum task comprises a classical computing component and a quantum computing component; the classical computing component comprises a classical constraint specifying a type of classical computing system to initiate the quantum task; and the quantum computing component comprises the quantum constraint.

6. The hybrid computing system of claim 1 wherein the workflow metadata comprises a plurality of task data objects corresponding to the plurality of tasks, and one or more data links between the plurality of task data objects specifying one or more input-output relationships between the plurality of task data objects.

7. The hybrid computing system of claim 6 wherein the metadata of the job schedule excludes the one or more data links between the plurality of task data objects.

8. The hybrid computing system of claim 1 wherein the plurality of tasks comprise the one or more constraints associated with each task of the plurality of tasks, at least one function associated with each task of the plurality of tasks, and at least one argument associated with each task of the plurality of tasks; and the dispatcher server system excludes the at least one function associated with each task of the plurality of tasks, and excludes the at least one argument associated with each task of the plurality of tasks, while extracting the workflow metadata.

9. The hybrid computing system of claim 1 wherein, after the scheduler server system transmits the metadata of the job schedule to the dispatcher server system, the scheduler server system deletes the workflow metadata and the metadata of the job schedule from the memory system of the scheduler server system.

10. The hybrid computing system of claim 1 wherein the memory system of the dispatcher server system stores thereon a plurality of constraints in a hierarchical data tree structure, and the one or more constraints that are associated with each task of the plurality of tasks are selected from the plurality of constraints.

11. The hybrid computing system of claim 10 wherein a given selected constraint associated with a given task is a child constraint associated with a parent constraint in the hierarchical data tree structure, and the dispatcher server system automatically applies the parent constraint to the given task.

12. A computing system for scheduling computing resources, comprising:
a non-transitory computer readable medium storing thereon at least executable instructions for a workflow application, the executable instructions comprising:
receiving a plurality of task nodes that define a workflow project representable as a directed graph structure, each one of the plurality of task nodes comprising a computing task and one or more constraints corresponding to the computing task, the one or more constraints specifying at least a type of computing hardware resource to execute the computing task;
generating workflow metadata from the workflow project, the workflow metadata comprising:
a plurality of task data objects corresponding to the plurality of task nodes, each one of the plurality of task data objects comprising the one or more constraints extracted from the workflow project, and
one or more data links between the plurality of task data objects specifying one or more input-output relationships between the plurality of task data objects;
transmitting the workflow metadata file to a scheduler server system and, in response, receiving scheduled jobs metadata that comprises a plurality of job data objects corresponding to the plurality of task data objects, and the plurality of job data objects respectively specifies a plurality of computing devices to respectively execute the computing task of each of the plurality of task nodes; and
combining at least the workflow project and the scheduled jobs metadata to transmit a given computing task of a given task node to a given specified computing device for execution, wherein the given computing task is obtained from the workflow project and the given specified computing device is obtained from the scheduled jobs metadata;
a processor system configured to execute the executable instructions; and
a communication system is configured to at least receive the workflow project, transmit the workflow metadata, receive the scheduled jobs metadata, and transmit the given computing task of the given task node to the given specified computing device.

13. The computing system of claim 12 wherein the plurality of task nodes comprises a quantum task node, which comprises a constraint specifying a quantum computing device and a computing task comprising a quantum task.

14. The computing system of claim 13 wherein the plurality of task data objects in the workflow metadata comprises a quantum task data object corresponding to the quantum task node; the plurality of job data objects in the scheduled jobs metadata comprises a quantum job data object; the quantum job data object comprises a classical component and a quantum component; the classical component comprises one or more parameters of a classical computing system; the quantum component comprises one or more parameters of a quantum computing device; and, the classical computing device is used to initiate the quantum computing device to execute the quantum task.

15. The computing system of claim 14 wherein the classical component further comprises one or more metrics associated with the classical computing system.

16. The computing system of claim 15 wherein the one or more metrics comprises at least one of an estimated queue time and an estimated cost to use the classical computing system to initiate the quantum computing device.

17. The computing system of claim 14 wherein the quantum component further comprises one or more metrics associated with the quantum computing device.

18. The computing system of claim 17 wherein the one or more metrics comprises at least one of an estimated queue time and an estimated cost to use the quantum computing device to execute the quantum task.

19. The computing system of claim 13 wherein the quantum computing device comprises at least one of: a gate-based quantum computing device, a measurement based quantum computing device, a quantum annealing device, and a quantum inspired hardware device.

20. The computing system of claim 13 wherein the quantum computing device comprises a gate-based quantum computing device and the quantum task comprises a quantum circuit.

21. The computing system of claim 20 wherein the plurality of task data objects in the workflow metadata comprises a quantum task data object corresponding to the quantum task node, and the quantum task data object comprises at least one of a number of quantum gates and a number of qubits of the quantum circuit.

22. The computing system of claim 12 wherein the computing task in each one of the plurality of task nodes is encoded, and the executable instructions further comprises decoding the computing task in each one of the plurality of task nodes.

23. The computing system of claim 12 wherein each one of the plurality of task nodes further comprises a task name, and the executable instructions further comprises: generating a mapping between a generic ID and the task name; labelling a corresponding task data object in the plurality of task data objects with the generic ID; and storing the mapping in the non-transitory computer readable medium.

24. A computing system for scheduling computing resources, comprising:
a non-transitory computer readable medium storing thereon at least executable instructions of a scheduler application, the executable instructions comprising:
receiving workflow metadata, the workflow metadata comprising:
a plurality of task data objects, each one of the plurality of task data objects comprising one or more constraints specifying at least a type of computing hardware resource to execute an unspecified computing task, and
one or more data links between the plurality of task data objects specifying one or more input-output relationships between the plurality of task data objects;
creating a plurality of job data objects corresponding to the plurality of task data objects;
assigning at least one computing system to the each one of the plurality of job data objects to execute, respectively, the unspecified computing task corresponding to the each one of the plurality of task data objects, and the at least one computing system satisfying, respectively, the one or more constraints corresponding to the each one of the plurality of task data objects;
assigning one or more parameters associated with the each of the at least one computing system assigned to the each one of the plurality of job data objects;
creating and transmitting a scheduled jobs metadata file comprising the plurality of job data objects, which comprises the at least one computing system assigned to the each one of the plurality of job data objects and the one or more parameters that are respectively associated therewith;
deleting from the non-transitory computer readable medium workflow data and the scheduled jobs metadata file;
a processor system configured to execute the executable instructions; and
a communication system is configured to at least receive the workflow metadata and transmit the scheduled jobs metadata file.

25. The computing system of claim 24 wherein the plurality of task data objects in the workflow metadata comprises a quantum task data object and the executable instructions further comprise generating creating a quantum job data object that is part of the plurality of job data objects, and
wherein: the quantum job data object comprises a classical component and a quantum component; the classical component comprises one or more parameters of a classical computing system; the quantum component comprises one or more parameters of a quantum computing device; and, the classical computing device is used to initiate the quantum computing device to execute an unspecified quantum task associated with the quantum task data object.

26. The computing system of claim 25 wherein the classical component further comprises one or more metrics associated with the classical computing system.

27. The computing system of claim 25 wherein the quantum component further comprises one or more metrics associated with the quantum computing device.

28. The computing system of claim 25 wherein the quantum computing device comprises at least one of: a gate-based quantum computing device, a quantum annealing device, and a quantum inspired hardware device.

29. The computing system of claim 25 wherein the quantum computing device comprises a gate-based quantum computing device and the quantum task comprises a quantum circuit.

30. The computing system of claim 24 wherein the plurality of task data objects in the workflow metadata comprises a quantum task data object that comprises one or more constraints specifying a quantum computing device, and the quantum task data object comprises at least one of a number of quantum gates and a number of qubits of the quantum circuit.
